(19) United States
(12) Patent Application Publication
(10) Pub. No.: US 2021/0033886 A1
(43) Pub. Date: Feb. 4, 2021

(54) LENS FOR SPECTACLES AND SPECTACLES

(71) Applicant: FUJIFILM Corporation, Tokyo (JP)

(72) Inventor: Takashi KATOU, Shizuoka (JP)

(73) Assignee: FUJIFILM Corporation, Tokyo (JP)

(21) Appl. No.: 17/071,984

(22) Filed: Oct. 15, 2020

Related U.S. Application Data
(63) Continuation of application No. PCT/JP2019/015186, filed on Apr. 5, 2019.

(30) Foreign Application Priority Data
Apr. 18, 2018 (JP) 2018-080033

(51) Int. Cl. G02C 7/02; G02C 7/10; C08G 75/06; G02B 1/04; C08K 5/353; C08K 5/357; C08K 5/45

(52) U.S. Cl. CPC G02C 7/022; G02C 7/104; C08G 75/06; C08K 5/45; C08K 5/353; C08K 5/357; G02B 1/041

(57) ABSTRACT

Provided are a lens for spectacles containing a resin having a refractive index of 1.65 or more and an ultraviolet absorbing agent A having, in a case where an absorbance at a maximum absorption wavelength is 1.0, an absorbance ratio at 410 nm of 0.10 or less and an absorbance ratio at 400 nm of 0.1 or more, where a proportion of the absorbance ratio at 400 nm to the absorbance ratio at 410 nm is 5.0 or more, and spectacles.

### CROSS-REFERENCE TO RELATED APPLICATIONS

This application is a continuation application of International Application No. PCT/JP2019/015186, filed Apr. 5, 2019, the disclosure of which is incorporated herein by reference in its entirety. Further, this application claims priority from Japanese Patent Application No. 2018-080033, filed Apr. 18, 2018, the disclosure of which is incorporated herein by reference in its entirety.

### BACKGROUND OF THE INVENTION

### 1. Field of the Invention

The present disclosure relates to a lens for spectacles and spectacles.

### 2. Description of the Related Art

Blue light emitted from a display such as an image display device or a small terminal equipped with a touch panel is known to be a factor causing eye strain.

In recent years, attempts have been made to reduce the influence of blue light on the eye by allowing a lens for spectacles to absorb blue light (particularly, light in the wavelength range of 380 nm to 400 nm). For example, various ultraviolet absorbing agents having an absorptivity to blue light are added in a composition for forming a lens for spectacles.

Further, various attempts have been made to obtain a lens for spectacles having a high refractive index for the reason that increasing the refractive index of the lens for spectacles is advantageous for making the lens thin.

For example, JP2004-315556A discloses a composition for an optical material which contains, as essential components, (A) an episulfide-based compound having a specific structure, (B) an inorganic compound having a sulfur atom and/or a selenium atom, (C) an SH group-containing organic compound having one or more SH groups in one molecule, and (D) an ultraviolet absorbing agent (for example, benzotriazole-based ultraviolet absorbing agent), in which the component (C) is added so as to have a specific content coefficient. JP2004-315556A also discloses that the composition for an optical material can be applied as a base material for spectacle lenses.

Further, JP2010-084006A discloses a plastic lens which is formed from a composition containing an episulfide resin, a sulfur atom, and a benzotriazole-based ultraviolet absorbing agent having a specific structure, in which the plastic lens contains 5 to 30 mass % sulfur atom and 0.5 to 5 mass % ultraviolet absorbing agent with respect to the total amount of the composition.

### SUMMARY OF THE INVENTION

However, depending on the kind of the ultraviolet absorbing agent, the benzotriazole-based ultraviolet absorbing agent may have poor compatibility with resin, which is a material of a plastic lens, and therefore the ultraviolet absorbing agent may be precipitated in the case of being applied to a lens for spectacles. Examples thereof include benzotriazole-based ultraviolet absorbing agents as disclosed in JP2004-315556A and JP2010-084006A. A plastic lens in which the ultraviolet absorbing agent is precipitated has a high haze and a low transparency, and thus tends to be inferior in suitability as a lens for spectacles.

Further, a lens for spectacles containing a benzotriazole-based ultraviolet absorbing agent cannot sufficiently block blue light having a wavelength near 400 nm.

Further, since the lens performance is enhanced as the refractive index of the lens for spectacles is increased, it is also an object of the present disclosure to block blue light having a wavelength near 400 nm even in a lens for spectacles having a high refractive index.

Furthermore, it is generally required for a lens for spectacles that a change in tint is hardly recognized in a case where an object is viewed through the lens.

An object of an embodiment of the present invention is to provide a lens for spectacles having a high refractive index (1.65 or more) and capable of blocking blue light in a wavelength range of at least 380 inn to 400 nm, in which a change in tint is hardly recognized in a case where an object is viewed through the lens.

An object of another embodiment of the present invention is to provide spectacles comprising the lens for spectacles.

Means for solving the above problems include the following aspects:

<1> A lens for spectacles comprising: a resin having a refractive index of 1.65 or more; and an ultraviolet absorbing agent A having, in a case where an absorbance at a maximum absorption wavelength is 1.0, an absorbance ratio at 410 nm of 0.10 or less and an absorbance ratio at 400 nm of 0.1 or more, where a proportion of the absorbance ratio at 400 nm to the absorbance ratio at 410 mu is 5.0 or more.

<2> The lens for spectacles according to <1>, in which the ultraviolet absorbing agent A is at least one selected from the group consisting of a benzoxazole compound, a benzoxazinone compound, and a benzodithiolane compound.

<3> The lens for spectacles according to <1> or <2>, in which the ultraviolet absorbing agent A is at least one selected from the group consisting of a compound represented by Formula (1), a compound represented by Formula (2), a compound represented by Formula (3), and a compound represented by Formula (4).

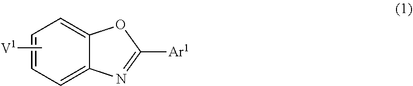

In Formula (1), V¹ represents a hydrogen atom or a monovalent substituent, and Ar¹ represents an aryl group or a heteroaryl group.

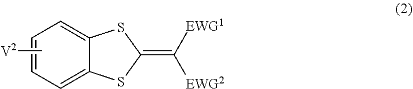

In Formula (2), EWG¹ and EWG² each independently represent a group having a Hammett substituent constant σp value of 0.2 or more, and V² represents a hydrogen atom or a monovalent substituent.

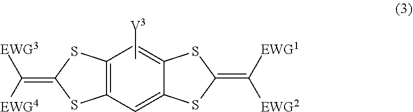

in Formula (3), EWG¹, EWG², EWG³, and EWG⁴ each independently represent a group having a Hammett substituent constant σp value of 0.2 or more, and V³ represents a hydrogen atom or a monovalent substituent.

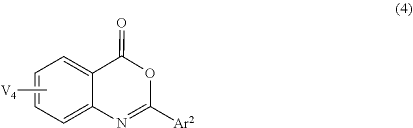

In Formula (4), V⁴ represents a hydrogen atom or a monovalent substituent, and Ar² represents an aryl group or a heteroaryl group.

<4> The lens for spectacles according to <3>, comprising the compound represented by Formula (1), in which V¹ in Formula (1) contains an alkoxy group.

<5> The lens for spectacles according to <3> or <4>, comprising the compound represented by Formula (1), in which Ar¹ in Formula (1) is a thiophene group.

<6> The lens for spectacles according to <3>, comprising the compound represented by Formula (4), in which Ar² in Formula (4) is a thiophene group.

<7> The lens for spectacles according to <3>, comprising the compound represented by Formula (2), in which, in Formula (2), EWG¹ and EWG² each independently represent —COOR⁶, —SO₂R⁷, —CN, or —COR⁸, where R⁷ represents an aryl group, and R⁶ and R⁸ each independently represent an alkyl group.

<8> The lens for spectacles according to <3>, comprising the compound represented by Formula (3), in which, in Formula (3), EWG¹, EWG², EWG³, and EWG⁴ each independently represent —COOR⁶, —SO₂R⁷, —CN, or —COR⁸, where R⁷ represents an aryl group, and R⁶ and R⁸ each independently represent an alkyl group.

<9> The lens for spectacles according to any one of <1> to <8>, in which the resin is an episulfide resin.

<10> The lens for spectacles according to any one of <1> to <9>, which has a refractive index of 1.70 or more.

<11> The lens for spectacles according to any one of <1> to <10>, further comprising an ultraviolet absorbing agent B different from the ultraviolet absorbing agent A, in which the ultraviolet absorbing agent B is at least one selected from a benzotriazole compound or a benzotriazine compound.

<12> Spectacles comprising the lens for spectacles according to any one of <1> to <11>.

According to an embodiment of the present invention, there is provided a lens for spectacles having a high refractive index (1.65 or more) and capable of blocking blue light in a wavelength range of at least 380 nm to 400 nm, in which a change in tint is hardly recognized in a case where an object is viewed through the lens.

According to another embodiment according to an aspect of the present invention, there are provided spectacles comprising the lens for spectacles.

### DESCRIPTION OF THE PREFERRED EMBODIMENTS

Hereinafter, a lens for spectacles and spectacles of the present disclosure will be described. However, the lens for spectacles and the spectacles according to the present disclosure is not limited to the following embodiments in any way, and modifications can be made as appropriate within the scope of the gist of the present disclosure.

In the present disclosure, a numerical range indicated by using “to” means a range including numerical values described before and after “to” as the minimum value and the maximum value, respectively.

In the numerical ranges described in a stepwise manner in the present disclosure, an upper limit value or a lower limit value described in a certain numerical range may be replaced with an upper limit value or a lower limit value in another numerical range described in a stepwise manner. Further, in the numerical ranges described in the present disclosure, the upper limit value or the lower limit value in a certain numerical range may be replaced with values described in Examples.

In the present disclosure, in a case where a plurality of substances corresponding to each component are present, a concentration or a content ratio of each component means a total concentration or a total content of the plurality of substances, unless otherwise specified.

In the present disclosure, a combination of two or more preferred aspects is a more preferable aspect.

In the present disclosure, the “blocking of blue light” encompasses not only a case where the blue light is completely blocked but also a case where at least a part of the blue light through a lens for spectacles is blocked to reduce the transmittance of the blue light.

[Lens for Spectacles]

A lens for spectacles of the present disclosure contains a resin having a refractive index of 1.65 or more, and an ultraviolet absorbing agent A having, in a case where an absorbance at a maximum absorption wavelength is 1.0, an absorbance ratio at 410 nm of 0.10 or less and an absorbance ratio at 400 nm of 0.1 or more, where a proportion of the absorbance ratio at 400 nm to the absorbance ratio at 410 nm is 5.0 or more (hereinafter, sometimes simply referred to as “ultraviolet absorbing agent A”).

The lens for spectacles according to the present disclosure has a high refractive index of 1.65 or more and is capable of blocking blue light in a wavelength range of at least 380 nm to 400 nm, in which a change in tint is hardly recognized in a case where an object is viewed through the lens. Although the reason that the lens for spectacles according to the present disclosure can exhibit such an effect is not clear, the present inventors assume as follows.

Blue light in the wavelength range of 380 nm to 400 nm can be blocked to some extent by an ultraviolet absorbing agent having a maximum absorption in the wavelength range of 380 nm to 400 nm.

However, depending on the kind of the ultraviolet absorbing agent, in a case where the ultraviolet absorbing agent is applied to a plastic lens formed of a resin having a refractive index higher than 1.65, the ultraviolet absorbing agent may be easily precipitated and increase the haze. Therefore, in a plastic lens having a refractive index higher than 1.65, even in a case where an ultraviolet absorbing agent having a maximum absorption in the wavelength range of 380 nm to 400 nm is applied, the plastic lens tends to be inferior in suitability as a lens for spectacles depending on the kind of the ultraviolet absorbing agent.

Under such circumstances, the present inventors have found, although the reason is not clear, that an ultraviolet absorbing agent included in ultraviolet absorbing agent A having, in a case where an absorbance at a maximum absorption wavelength is 1.0, an absorbance ratio at 410 nm of 0.10 or less and an absorbance ratio at 400 nm of 0.1 or more, where a proportion of the absorbance ratio at 400 nm to the absorbance ratio at 410 nm (that is, absorbance ratio at 400 nm/absorbance ratio at 410 nm) is 5.0 or more, has satisfactory compatibility in a case where the ultraviolet absorbing agent is combined with a resin used for plastic lenses for spectacles having a maximum absorption in the wavelength range of 380 nm to 400 nm and a refractive index higher than 1.65. As a result, the lens for spectacles of the present disclosure is considered to have a secondary effect of having suitability as a spectacle lens having low haze and excellent transparency while having a blue light-blocking property in the wavelength range of 380 nm to 400 nm.

Accordingly, the lens for spectacles of the present disclosure is also considered to be advantageous in that the transparency, which is one of the characteristics of the lens for spectacles, is maintained for a long period of time as it suppresses a decrease in transparency of the lens for spectacles, and the light resistance of the lens is thus further improved.

Further, the ultraviolet absorbing agent A contained in the lens for spectacles of the present disclosure has a sharp peak at the maximum absorption wavelength in the absorption spectrum, and has extremely low absorptivity of light at a wavelength on a shorter wavelength side or a longer wavelength side than the maximum absorption wavelength. Therefore, in a case where such an ultraviolet absorbing agent A is applied to a lens for spectacles, the lens hardly has a yellowish tint. Accordingly, it is considered that with respect to the lens for spectacles according to the present disclosure which contains the above ultraviolet absorbing agent A, a change in tint is hardly recognized in a case where an object is viewed through the lens.

Furthermore, since the lens for spectacles of the present disclosure is allowed to have a refractive index of 1.65 or more, the thickness of the lens can be reduced, and the reduction in weight of the lens can be easily realized.

With respect to the lens for spectacles of the present disclosure, lenses for spectacles disclosed in JP2004-315556A and JP2010-084006A contain a benzotriazole-based ultraviolet absorbing agent. It is considered that the benzotriazole-based ultraviolet absorbing agent cannot sufficiently block blue light having a wavelength near 400 nm because the molar absorption coefficient at a wavelength near 400 mu is not high. That is, the benzotriazole-based ultraviolet absorbing agents disclosed in JP2004-315556A and JP2010-084006A are ultraviolet absorbing agents that are not included in the ultraviolet absorbing agent A according to the present disclosure.

Further, since the benzotriazole-based ultraviolet absorbing agent contained in the lenses for spectacles disclosed in JP2004-315556A and JP2010-084006A can absorb light having a wavelength of around 450 nm, the lens for spectacles tends to have a yellowish tint. Accordingly, it is considered that with respect to the lenses for spectacles disclosed in JP2004-315556A and JP2010-084006A, a change in tint is easily recognized in a case where an object is viewed through the lenses.

Furthermore, since the benzotriazole-based ultraviolet absorbing agent contained in the lenses for spectacles disclosed in JP2004-315556A and JP2010-084006A has poor compatibility with resin, which is a material of the plastic lens, and therefore the ultraviolet absorbing agent may be precipitated in the case of being applied to the lens for spectacles. Accordingly, the lenses for spectacles disclosed in JP2004-315556A and JP2010-084006A have high haze and low transparency, and thus are considered to be inferior in suitability as a lens for spectacles.

However, the above assumption is not intended to limit the effect of the lens for spectacles of the present disclosure, but is intended to describe the effect as an example.

Hereinafter, each component in the lens for spectacles of the present disclosure will be described in detail.

[Ultraviolet Absorbing Agent A]

A lens for spectacles of the present disclosure contains an ultraviolet absorbing agent A having, in a case where an absorbance at a maximum absorption wavelength is 1.0, an absorbance ratio at 410 nm of 0.10 or less and an absorbance ratio at 400 nm of 0.10 or more, where a proportion of the absorbance ratio at 400 nm to the absorbance ratio at 410 nm is 5.0 or more.

The ultraviolet absorbing agent A has, in a case where the absorbance at the maximum absorption wavelength is 1.0, an absorbance ratio at 400 nm of 0.10 or more, preferably 0.20 or more, and more preferably 0.30 or more. The ultraviolet absorbing agent A has, in a case where the absorbance at the maximum absorption wavelength is 1.0, an absorbance ratio at 410 nm of 0.1 or less, preferably 0.08 or less, and more preferably 0.06 or less.

In the ultraviolet absorbing agent A, the proportion of the absorbance ratio at 410 nm to the absorbance ratio at 400 nm (that is, the absorbance ratio at 400 nm/the absorbance ratio at 410 nm) is 5.0 or more, and is preferably 6.0 or more, and more preferably 7.0 or more from the viewpoint of the blue light-blocking property, haze suppression, light resistance, and the suppression of lens tint.

The absorbance of the ultraviolet absorbing agent A can be confirmed by measuring an absorption spectrum in a chloroform solution at room temperature (25° C.) using a known absorptiometer. An example of the measuring instrument is, but is not limited to, a spectrophotometer (Model number: UV 3150) manufactured by Shimadzu Corporation.

The color value (molar absorption coefficient/molecular weight) of the ultraviolet absorbing agent A is preferably 30 to 200, more preferably 40 to 180, and even more preferably 50 to 160 from the viewpoint of achieving the blue light-blocking property with a smaller content.

The ultraviolet absorbing agent A is preferably at least one selected from the group consisting of a benzoxazole compound, a benzoxazinone compound, and a benzodithiolane compound.

<Specific Compound>

A more suitable aspect of the ultraviolet absorbing agent A is at least one selected from the group consisting of a compound represented by Formula (1), a compound represented by Formula (2), a compound represented by Formula (3), and a compound represented by Formula (4). Hereinafter, among the ultraviolet absorbing agents A, the compounds represented by Formula (1), Formula (2), Formula (3), and Formula (4) are collectively referred to as “specific compound” as appropriate.

The specific compound is a compound having an ultraviolet absorbing ability capable of absorbing blue light in a wavelength range of 380 nm to 400 nm.

Adding the specific compound allows the lens for spectacles of the present disclosure to block blue light in a wavelength range of at least 380 nm to 400 nm, and thus to exhibit an effect of causing a change in tint to be hardly recognized in a case where an object is viewed through the lens. Further, the lens for spectacles of the present disclosure containing the specific compound hardly causes haze, has excellent light resistance, hardly has a yellowish tint, and has sufficient suitability as a lens used for spectacles.

Hereinafter, prior to the detailed description of the specific compound, first, the “monovalent substituent” in the present disclosure will be described in detail. The “monovalent substituent” as used herein means the “monovalent substituent” included in the definition of V¹ in Formula (1), V² in Formula (2), V³ in Formula (3), or V⁴ in Formula (4) described below.

Hereinafter, the “monovalent substituent” will be collectively described, but in a case where V¹ in Formula (1), V² in Formula (2), V³ in Formula (3), or V⁴ in Formula (4) represents a monovalent substituent, it goes without saying that these monovalent substituents are each an independent substituent.

Examples of the “monovalent substituent” in the present disclosure include an alkyl group, an alkenyl group, an alkynyl group, an alkoxy group, an aryl group, an aralkyl group, an —SR group, an —NR group, a —C(═O)OR group, an —OC(═O)R group, an —OC(═O)OR group, an —OC(═O)NHR group, an —OC(═O)N(R)₂ group, an acetyl group, a carboxy group, a nitro group, and a halogen atom. Each R independently represents an alkyl group.

The alkyl group may be an unsubstituted alkyl group or a substituted alkyl group.

Here, the “substituted alkyl group” means an alkyl group in which a hydrogen atom of the alkyl group is substituted with another substituent. In the same manner, the substituted alkenyl group, the substituted alkynyl group, and the substituted aralkyl group mean those in which a hydrogen atom of each group is substituted with another substituent. The “other substituent” mentioned here will be described below.

The alkyl group may have a linear, branched, or cyclic molecular structure.

The number of carbon atoms of the alkyl group is preferably 1 to 20 and more preferably 1 to 18. The number of carbon atoms in this case does not include the number of carbon atoms of the substituent in a case where the alkyl group further has a substituent.

The alkenyl group may be an unsubstituted alkenyl group or a substituted alkenyl group.

The alkenyl group may have a linear, branched, or cyclic molecular structure.

The number of carbon atoms of the alkenyl group is preferably 2 to 20 and more preferably 2 to 18. The number of carbon atoms in this case does not include the number of carbon atoms of the substituent in a case where the alkenyl group further has a substituent.

The alkynyl group may be an unsubstituted alkynyl group or a substituted alkynyl group.

The alkynyl group may have a linear, branched, or cyclic molecular structure.

The number of carbon atoms of the alkynyl group is preferably 2 to 20 and more preferably 2 to 18. The number of carbon atoms in this case does not include the number of carbon atoms of the substituent in a case where the alkynyl group further has a substituent.

The alkoxy group may be an unsubstituted alkoxy group or a substituted alkoxy group.

The number of carbon atoms of the alkoxy group is preferably 1 to 20. The number of carbon atoms in this case does not include the number of carbon atoms of the substituent in a case where the alkoxy group further has a substituent.

The aryl group may be an unsubstituted aryl group or a substituted aryl group.

The number of carbon atoms of the aryl group is preferably 6 to 20 and more preferably 6 to 10. The number of carbon atoms in this case does not include the number of carbon atoms of the substituent in a case where the aryl group further has a substituent.

The aralkyl group may be an unsubstituted aralkyl group or a substituted aralkyl group.

The alkyl moiety of the aralkyl group is the same as the alkyl group which is the substituent described above.

The aryl moiety of the aralkyl group may be fused with an aliphatic ring, another aromatic ring, or a heterocyclic ring.

The aryl moiety of the aralkyl group is the same as the aryl group which is the substituent described above.

Examples of the halogen atom include a fluorine atom, a chlorine atom, and a bromine atom.

The substituents included in the substituted alkyl group, the substituted alkenyl group, the substituted alkynyl group, the substituted aryl group, and the substituted aralkyl group (that is, other substituents) can be freely selected from the following substituent group.

Substituent group: a halogen atom, an alkyl group, an alkenyl group, an alkynyl group, an aryl group, a heterocycle group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, alkyl- and aryl-sulfonylamino groups, a mercapto group, an alkylthio group, an arylthio group, a heterocyclic thio group, a sulfamoyl group, a sulfo group, alkyl- and aryl-sulfinyl groups, alkyl- and aryl-sulfonyl groups, an acyl group, an aryloxycarbonyl group, an alkoxycarbonyl group, a carbamoyl group, an arylazo group, a heterocyclic azo group, an imide group, a phosphino group, a phosphinyl group, a phosphinyloxy group, a phosphinylamino group, and a silyl group.

For details of the examples of the substituent included in the substituted alkyl group, the substituted alkenyl group, the substituted alkynyl group, and the substituted aralkyl group, refer to the disclosure of JP2007-262165A.

Next, the compound represented by Formula (1), the compound represented by Formula (2), the compound represented by Formula (3), and the compound represented by Formula (4) will be described.

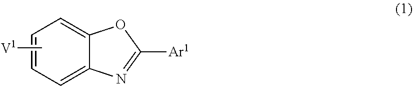

In Formula (1), V¹ represents a hydrogen atom or a monovalent substituent, and Ar¹ represents an aromatic ring or a heterocycle.

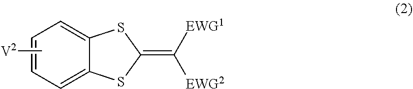

In Formula (2), EWG¹ and EWG² each independently represent a group having a Hammett substituent constant up value of 0.2 or more. V² represents a hydrogen atom or a monovalent substituent.

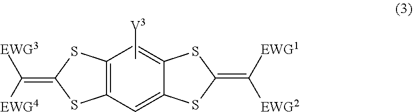

In Formula (3), EWG¹ to EWG⁴ each independently represent a group having a Hammett substituent constant op value of 0.2 or more. V³ represents a hydrogen atom or a monovalent substituent.

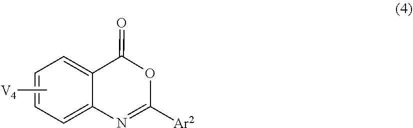

In Formula (4), V⁴ represents a hydrogen atom or a monovalent substituent, and Ar² represents an aryl group or a heteroaryl group.

The compound represented by Formula (1) may be a dimer in which two residues are bonded via Ar¹. Further, the compound represented by Formula (4) may be a dimer in which two residues are bonded via Ar².

In Formula (1), the number of monovalent substituents represented by V¹ may be 1 or 2 to 4, and is preferably 2.

In Formula (1), examples of the monovalent substituent represented by V¹ include the monovalent substituents described above, and preferred is an alkyl group or an alkoxy group, and more preferred is an alkyl group having 2 to 30 carbon atoms or an alkoxy group having 2 to 30 carbon atoms.

The compound represented by Formula (1) particularly preferably contains an alkoxy group as the monovalent substituent represented by V¹ from the viewpoint of blue light-blocking property.

In Formula (2), the number of monovalent substituents represented by V² may be 1 or 2 to 4, and is preferably 2.

In Formula (2), examples of the monovalent substituent represented by V² include the monovalent substituents described above, and preferred is an alkyl group, an alkoxy group, an aryl group, an aryloxy group, an acyloxy group, an aryloxycarbonyl group, an alkoxycarbonyl group, a carbamoyl group, or a halogen atom, and more preferred is an alkyl group, an alkoxy group, an acyloxy group, an aryloxycarbonyl group, an alkoxycarbonyl group, or a carbamoyl group.

In Formula (3), the number of monovalent substituents represented by V³ may be 1 or 2, and is preferably 2.

In Formula (3), examples of the monovalent substituent represented by V³ include the monovalent substituents described above, and preferred is an alkyl group, an alkoxy group, an aryl group, an aryloxy group, an acyloxy group, an aryloxycarbonyl group, an alkoxycarbonyl group, a carbamoyl group, or a halogen atom, and more preferred is an alkyl group, an alkoxy group, an acyloxy group, an aryloxycarbonyl group, an alkoxycarbonyl group, or a carbamoyl group.

In Formula (4), the number of monovalent substituents represented by V⁴ may be 1 or 2 to 4, and is preferably 1 and more preferably 0 (that is, all V⁴s are hydrogen atoms).

In Formula (4), examples of the monovalent substituent represented by V⁴ include the monovalent substituents described above, and preferred is an alkyl group, an alkoxy group, an aryl group, an aryloxy group, an acyloxy group, an aryloxycarbonyl group, an alkoxycarbonyl group, a carbamoyl group, a nitro group, or a halogen atom, and more preferred is an alkyl group, an alkoxy group, or a halogen atom.

In Formula (1) or (4), the aryl group represented by Ar¹ or Ar² may be an unsubstituted aryl group or a substituted aryl group.

Further, the aryl group represented by Ar¹ or Ar² may be fused with an aliphatic ring, another aromatic ring, or a heterocyclic ring.

The number of carbon atoms of the aryl group represented by Ar¹ or Ar² is not particularly limited, and, for example, is preferably 6 to 30, more preferably 6 to 20, and even more preferably 6 to 15.

In a case where Ar¹ or Ar² is a substituted aryl group, the aryl moiety of the substituted aryl group is the same as the above aryl group. The substituent included in the substituted aryl group can be freely selected, for example from the substituent group described above.

In Formula (1), the aryl group represented by Ar¹ is preferably, for example, a phenyl group, a biphenyl group, a triphenyl group, a naphthyl group, an anthracenyl group, or a stilbene group, more preferably a phenyl group, a biphenyl group or a triphenyl group, and particularly preferably a phenyl group or a triphenyl group.

In Formula (4), the aryl group represented by Ar² is preferably, for example, a phenyl group, a pyridyl group, or a pyrazine group, and more preferably a phenyl group.

The heteroaryl group represented by Ar¹ or Ar² may be an unsubstituted heteroaryl group or a substituted heteroaryl group. Further, the heteroaryl group may be fused with an aliphatic ring, an aromatic ring, or another heterocyclic ring.

The heteroaryl group preferably contains a 5-membered or 6-membered saturated or unsaturated heterocyclic ring.

Examples of the heteroatom in the heteroaryl group include a boron atom (B atom), a nitrogen atom (N atom), an oxygen atom (O atom), a sulfur atom (S atom), a selenium atom (Se atom), and a tellurium atom (Te atom), and preferred are N atom, O atom, and S atom.

With respect to the heteroaryl group, it is preferable that a carbon atom has a free valence (monovalent) (that is, the heteroaryl group is bonded to a carbon atom).

The number of carbon atoms of the heteroaryl group is not particularly limited, and, for example, is preferably 1 to 40, more preferably 1 to 30, and even more preferably 1 to 20.

Specific examples of the heteroaryl group include a thiophene group, a furan group, a thiazole group, a benzothiazole group, a benzoxazole group, a benzotriazole group, a benzoselenazole group, a pyridine group, a pyrimidine group, a pyrazine group, and a quinoline group.

In a case where Ar¹ or Ar² is a substituted heteroaryl group, the heteroaryl moiety of the substituted heteroaryl group is the same as the heteroaryl group described above.

The substituent included in the substituted heteroaryl group represented by Ar¹ or Ar² can be freely selected, for example, from the substituent group described above.

In Formula (1), the heteroaryl group represented by Ar¹ is particularly preferably a thiophene group from the viewpoint of the blue light-blocking property.

In Formula (4), the heteroaryl group represented by Ar² is preferably a thiophene group, a pyridine group, or a pyrazine group, and more preferably a thiophene group from the viewpoint of the blue light-blocking property.

In Formula (2) or (3), the upper limit of the Hammett substituent constant up value of the group represented by EWG¹, EWG², EWG³, or EWG⁴ is not particularly limited, and, for example, is preferably 1.0 or less.

The “Hammett substituent constant” according to the present disclosure is a constant specific to the substituent in the relational expression established as the Hammett rule. The positive Hammett substituent constant σ value indicates that the substituent is electron-withdrawing.

The Hammett rule is a rule of thumb proposed by L. P. Hammett in 1935 to quantitatively discuss the influence of substituents on the reaction or equilibrium of benzene derivatives, but is widely accepted today. Substituent constants determined by the Hammett rule include σp values and σm values. These values are disclosed in many general documents, for example, “Lange's Handbook of Chemistry” 12th Edition, edited by J. A. Dean, 1979 (Mc Graw-Hill) and “Special Issue of Field of Chemistry”, No. 122, pages 96 to 103, 1979 (Nankodo Co., Ltd.).

EWG¹ and EWG² in Formula (1) are regulated by the Hammett substituent constant σp value, the present invention is not limited to substituents having known values disclosed in these documents, and even substituents a having σp value not disclosed in these documents are also included in the present invention, as long as the value thereof determined based on the Hammett rule is 0.2 or more.

Examples of the group having a Hammett substituent constant σp value of 0.2 or more include a cyano group (0.66), a carboxy group (—COOH: 0.45), an alkoxycarbonyl group (—COOMe: 0.45, —COOC₈H₁₇: 0.44, —COOC₉H₁₉: 0.44, —COOC₁₃H₂₇: 0.44), an aryloxycarbonyl group (—COOPh: 0.44), a carbamoyl group (—CONH₂: 0.36), an acetyl group (—COMe: 0.50), an arylcarbonyl group (—COPh: 0.43), an alkylsulfonyl group (—SO₂Me: 0.72), and an arylsulfonyl group (—SO₂Ph: 0.68). Representative substituents and σp values thereof in the parentheses are from Chem. Rev., 1991, vol. 91, pages 165 to 195. Further, a sulfamoyl group, a sulfinyl group, a heterocyclic group and the like are also included in the group having a Hammett substituent constant op value of 0.2 or more.

In the present disclosure, “Me” represents a methyl group, and “Ph” represents a phenyl group.

From the viewpoint of blocking blue light in the wavelength range of 380 nm to 400 nm in a more satisfactory manner and causing a change in tint to be hardly recognized in a case where an object is viewed through the lens, EWG¹, EWG², EWG³, or EWG⁴ in Formula (2) or (3) preferably each independently represent —COOR⁶, SO₂R⁷, CN, or COR⁵, where R⁶, R⁷, and R⁸ each independently represent an alkyl group, an aryl group, or a heteroaryl group.

The alkyl group represented by R⁶, R⁷, or R⁸ may be an unsubstituted alkyl group or a substituted alkyl group.

Specific examples of EWG¹, EWG², EWG³, or EWG⁴ include an alkoxycarbonyl group, an arylcarbonyl group, an aryloxycarbonyl group, an alkylsulfonyl group, an arylsulfonyl group, a cyano group, an acyl group, and an aminocarbonyl group.

The number of carbon atoms of the alkoxycarbonyl group is not particularly limited, and for example, is preferably 2 to 20 and more preferably 2 to 9. Specific examples of the alkoxycarbonyl group having 2 to 20 carbon atoms include a methoxycarbonyl group, an ethoxycarbonyl group, a t-butoxycarbonyl group, an octyloxycarbonyl group, a nonyloxycarbonyl group, a tridecyloxycarbonyl group, and a benzyloxycarbonyl group.

The number of carbon atoms of the arylcarbonyl group is not particularly limited, and, for example, is preferably 7 to 20 and more preferably 7 to 15. Specific examples of the arylcarbonyl group having 7 to 20 carbon atoms include a phenylcarbonyl group.

The number of carbon atoms of the alkylsulfonyl group is not particularly limited, and, for example, is preferably 6 to 20 and more preferably 6 to 15. Specific examples of the alkylsulfonyl group having 6 to 20 carbon atoms include a hexylsulfonyl group, an octylsulfonyl group, and a dodecylsulfonyl group.

The number of carbon atoms of the arylsulfonyl group is not particularly limited, and, for example, is preferably 6 to 15. Examples of the arylsulfonyl group having 6 to 15 carbon atoms include a phenylsulfonyl group, a benzenesulfonyl group, a p-toluenesulfonyl group, a p-chlorobenzenesulfonyl group, and a naphthalenesulfonyl group.

The number of carbon atoms of the acyl group is not particularly limited, and, for example, is preferably 2 to 20 and more preferably 2 to 5. Specific examples of the acyl group having 2 to 20 carbon atoms include an acetyl group and a propionyl group.

The number of carbon atoms of the aryloxycarbonyl group is not particularly limited, and, for example, is preferably 7 to 20 and more preferably 7 to 15. Specific examples of the aryloxycarbonyl group having 7 to 20 carbon atoms include a phenoxycarbonyl group and a p-nitrophenoxycarbonyl group.

The number of carbon atoms of the aminocarbonyl group is not particularly limited, and, for example, is preferably 2 to 20 and more preferably 2 to 15. Specific examples of the aminocarbonyl group having 2 to 20 carbon atoms include N-methylaminocarbonyl group and N-ethylaminocarbonyl group.

Further, from the viewpoint of blocking blue light in the wavelength range of 380 nm to 400 nm in a more satisfactory manner and causing a change in tint to be hardly recognized in a case where an object is viewed through the lens, EWG¹ and EWG² in Formula (2) more preferably each independently represent —COOR⁶, —SO₂R⁷, —CN, or —COR^{E}, where R⁷ represents an aryl group, and R⁶ and R⁸ each independently represent an alkyl group.

In Formula (2), EWG¹ and EWG² may be linked to each other to form a ring.

From the viewpoint of blocking blue light in the wavelength range of 380 nm to 400 nm in a more satisfactory manner and causing a change in tint to be hardly recognized in a case where an object is viewed through the lens, EWG¹, EWG², EWG³, and EWG⁴ in Formula (3) more preferably each independently represent —COOR⁶, —SO₂R⁷, —CN, or —COR^{E}, where R⁷ represents an aryl group, and R⁶ and R⁸ each independently represent an alkyl group.

In Formula (3), EWG¹ and EWG², and EWG³ and EWG⁴ may be each independently linked to each other to form a ring.

In a particularly preferred aspect of EWG¹ and EWG² in Formula (2) and EWG¹, EWG², EWG³, and EWG⁴ in Formula (3), EWG¹ and EWG², and EWG³ and EWG⁴ are both a cyano group, a carbonyl group, or an aminocarbonyl group.

According to such an aspect, it is possible to realize a lens for spectacles having remarkably excellent blue light-blocking property in the wavelength range of 380 nm to 400 nm (particularly, blue light having a wavelength of 400 nm) and through which almost no change in tint is recognized in a case where an object is viewed through the lens.

Among the specific compounds described above, more preferred are the compound represented by Formula (1) and the compound represented by Formula (3).

Specific examples of the compound represented by Formula (1), the compound represented by Formula (2), the compound represented by Formula (3), and the compound represented by Formula (4) (that is, a specific compound) are shown below. Here, the specific compound is not limited to these example compounds.

Compound (I-1) to compound (1-23) are example compounds of the compound represented by Formula (1), compound (S-1) to compound (S-36) and compound (T-1) to compound (T-35) are example compounds of the compound represented by Formula (2), compound (B-1) to compound (B-40) are example compounds of the compound represented by Formula (3), and compound (U-1) to compound (U-25) are example compounds of the compound represented by Formula (4).

In the example compounds, Me represents a methyl group, Et represents an ethyl group, Bu represents a butyl group, Pr represents a propyl group, Hex represents a hexyl group, Ac represents an acetyl group, Ts represents a tosyl group, and Ph represents a phenyl group.

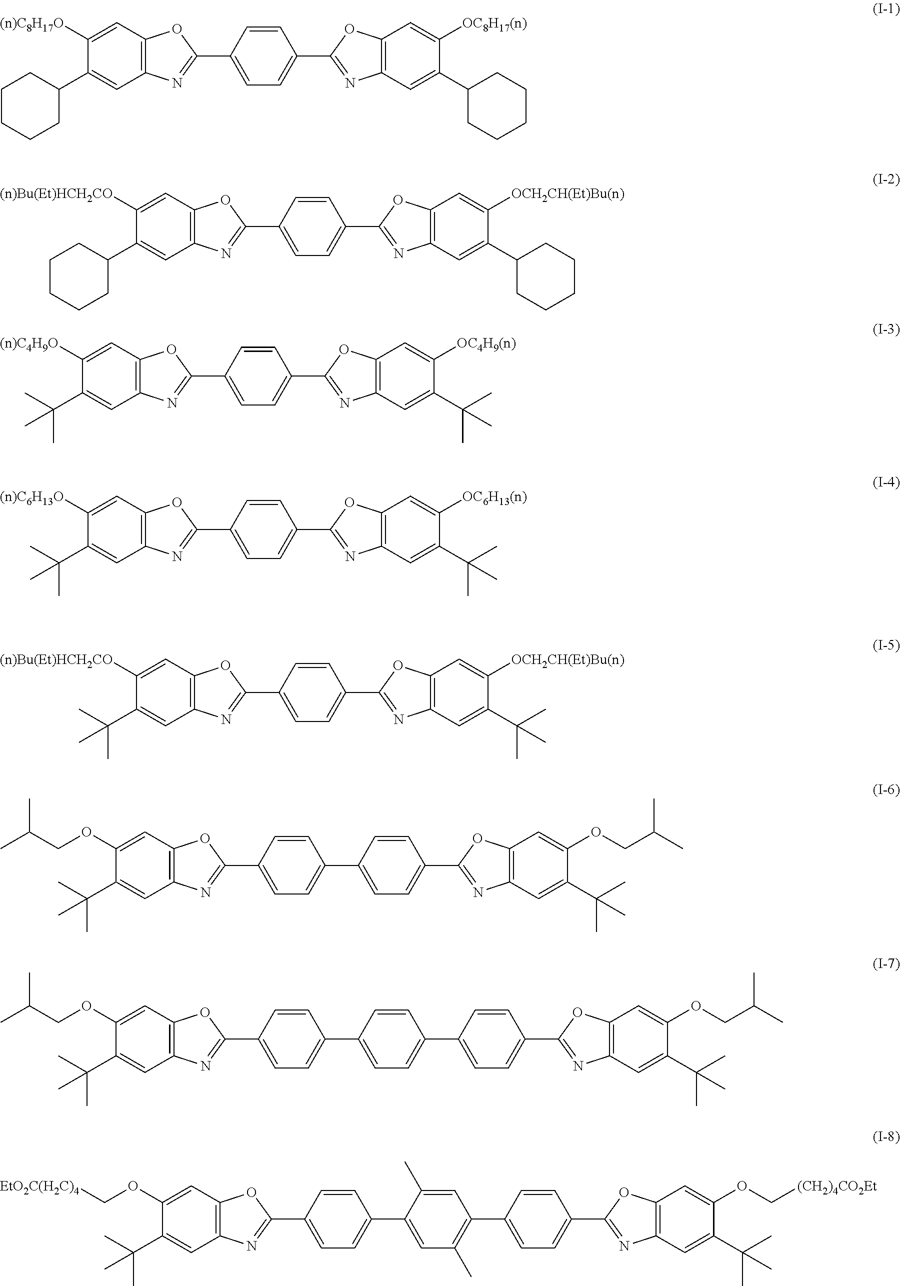

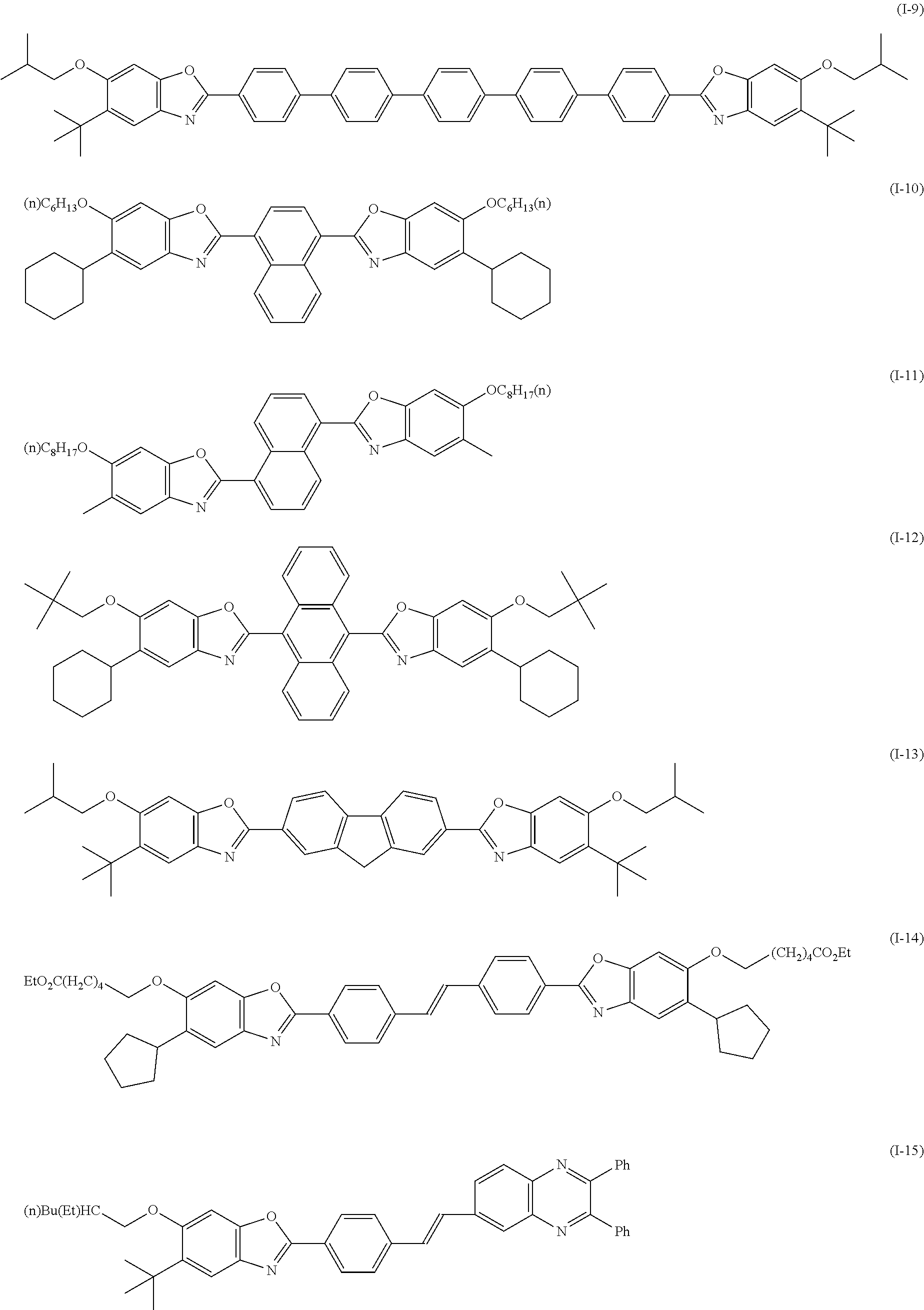

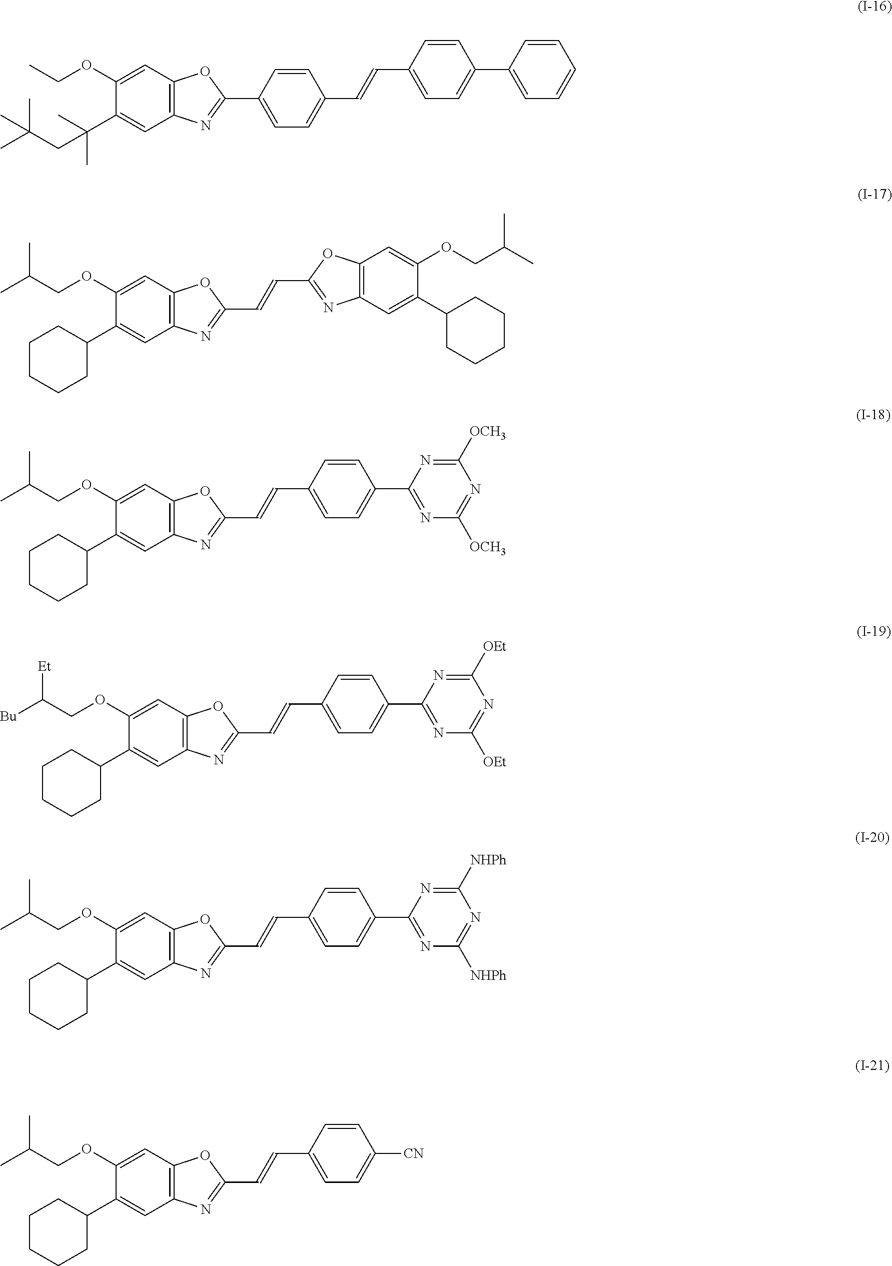

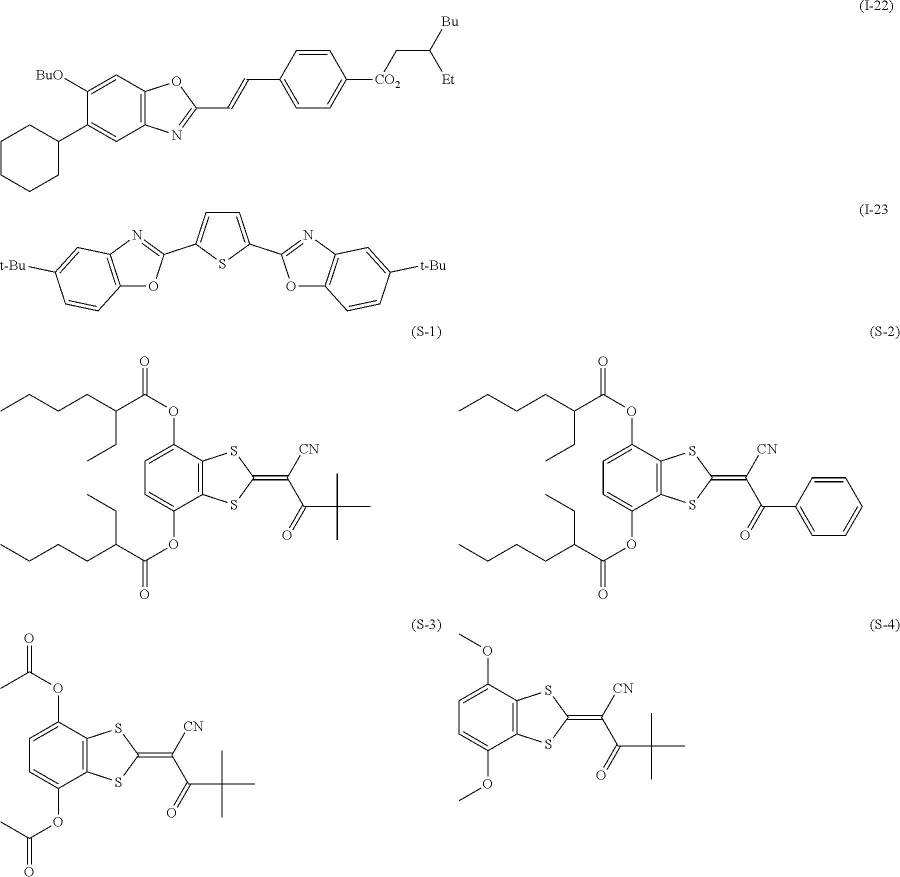

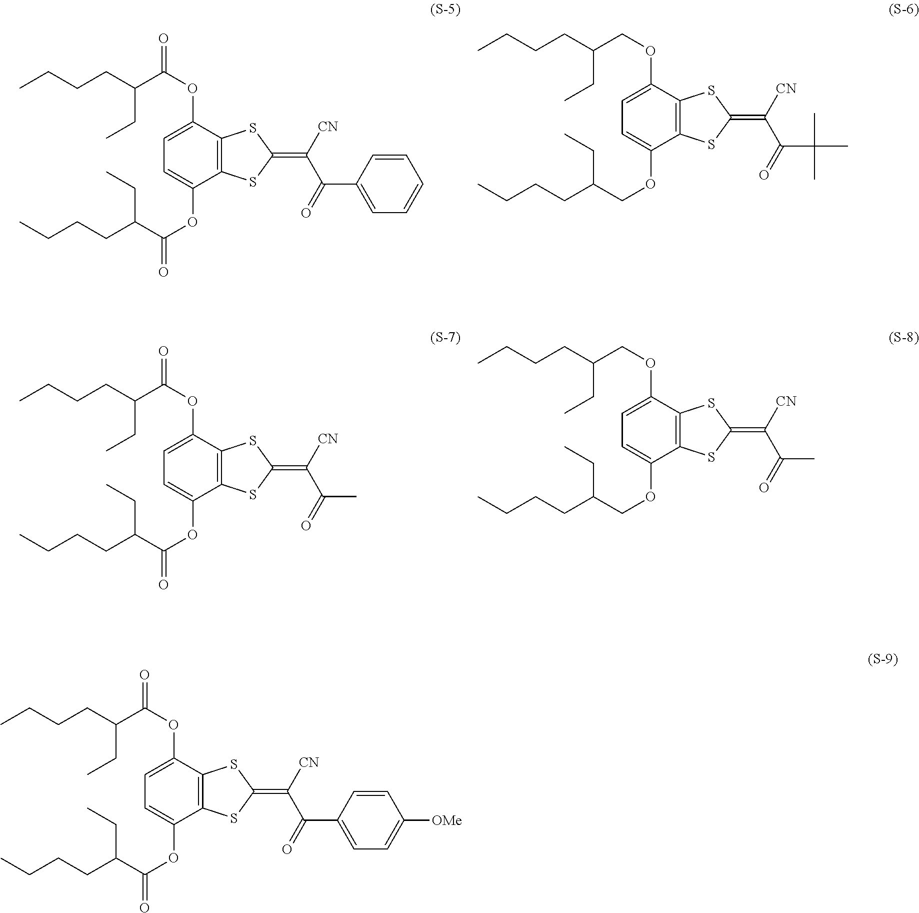 [SMILES: CCCCC(CC)C(=O)Oc1ccc(OC(=O)C(CC)CCCC)c2c1SC(=C(C#N)C(=O)c1ccccc1)S2 ; CCCCC(CC)COc1ccc(OCC(CC)CCCC)c2c1SC(=C(C#N)C(=O)C(C)(C)C)S2 ; CCCCC(CC)C(=O)Oc1ccc(OC(=O)C(CC)CCCC)c2c1SC(=C(C#N)C(C)=O)S2 ; CCCCC(CC)COc1ccc(OCC(CC)CCCC)c2c1SC(=C(C#N)C(C)=O)S2 ; "(S-9)" ; CCCCC(CC)C(=O)Oc1ccc(OC(=O)C(CC)CCCC)c2c1SC(=C(C#N)C(=O)c1ccc(OC)cc1)S2]

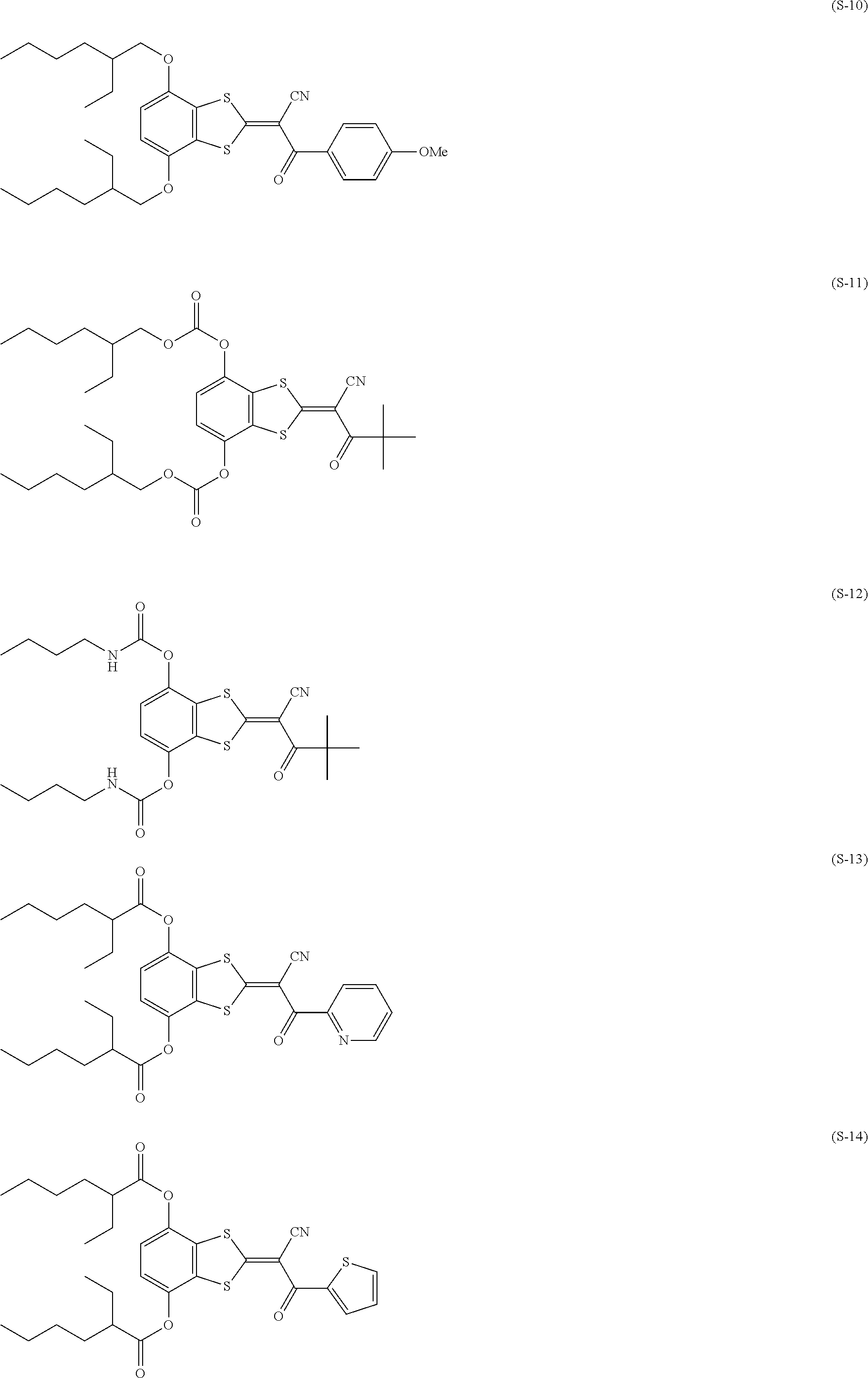

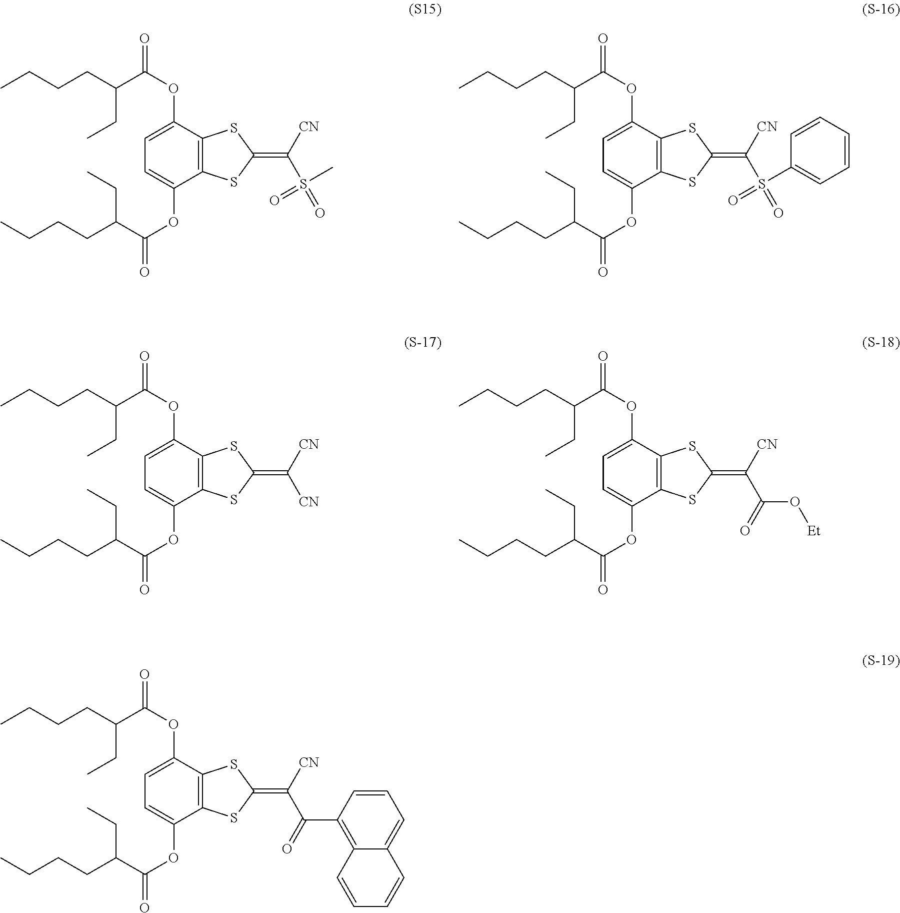 [SMILES: CCCCC(CC)C(=O)Oc1ccc(OC(=O)C(CC)CCCC)c2c1SC(=C(C#N)S(C)(=O)=O)S2 ; CCCCC(CC)C(=O)Oc1ccc(OC(=O)C(CC)CCCC)c2c1SC(=C(C#N)S(=O)(=O)c1ccccc1)S2 ; CCCCC(CC)C(=O)Oc1ccc(OC(=O)C(CC)CCCC)c2c1SC(=C(C#N)C#N)S2 ; CCCCC(CC)C(=O)Oc1ccc(OC(=O)C(CC)CCCC)c2c1SC(=C(C#N)C(=O)OCC)S2 ; CCCCC(CC)C(=O)Oc1ccc(OC(=O)C(CC)CCCC)c2c1SC(=C(C#N)C(=O)c1cccc3ccccc13)S2]

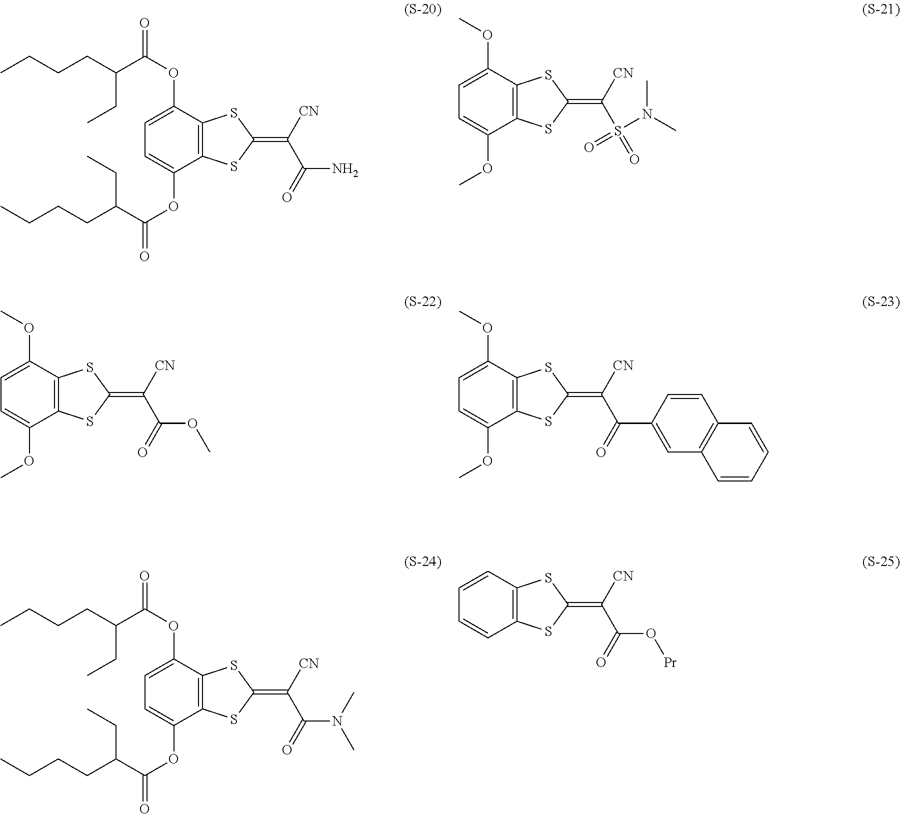

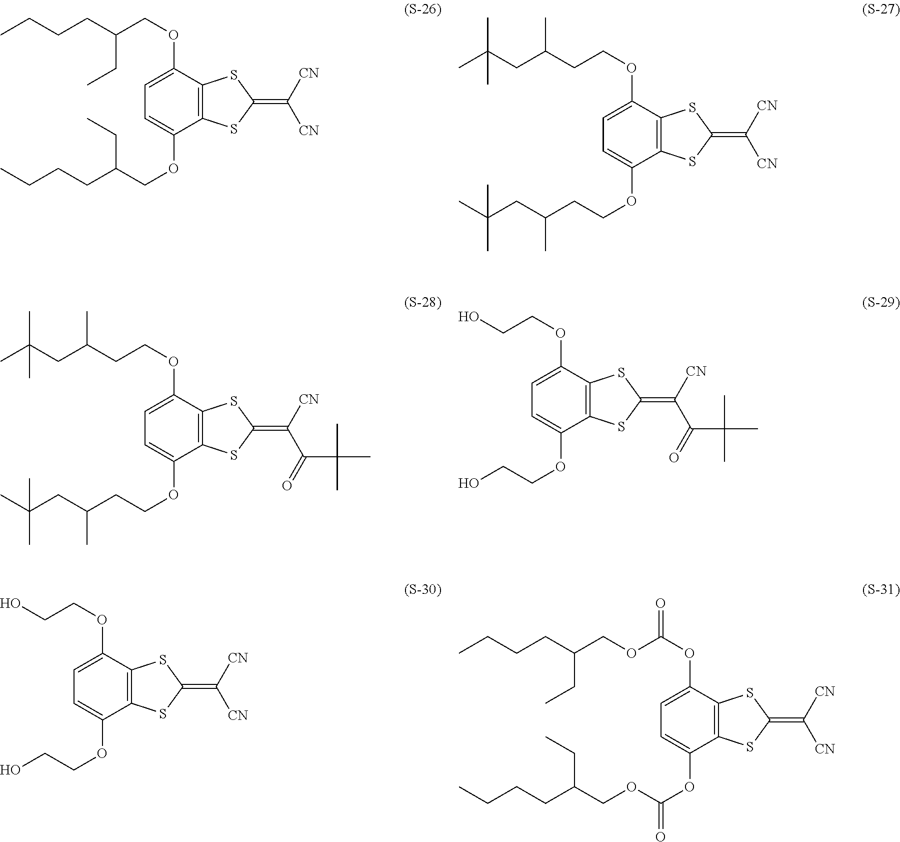 [SMILES: CCCCC(CC)COc1ccc(OCC(CC)CCCC)c2c1SC(=C(C#N)C#N)S2 ; CC(CCOc1ccc(OCCC(C)CC(C)(C)C)c2c1SC(=C(C#N)C#N)S2)CC(C)(C)C ; CC(CCOc1ccc(OCCC(C)CC(C)(C)C)c2c1SC(=C(C#N)C(=O)C(C)(C)C)S2)CC(C)(C)C ; CC(C)(C)C(=O)C(C#N)=C1Sc2c(OCCO)ccc(OCCO)c2S1 ; N#CC(C#N)=C1Sc2c(OCCO)ccc(OCCO)c2S1 ; CCCCC(CC)COC(=O)Oc1ccc(OC(=O)OCC(CC)CCCC)c2c1SC(=C(C#N)C#N)S2]

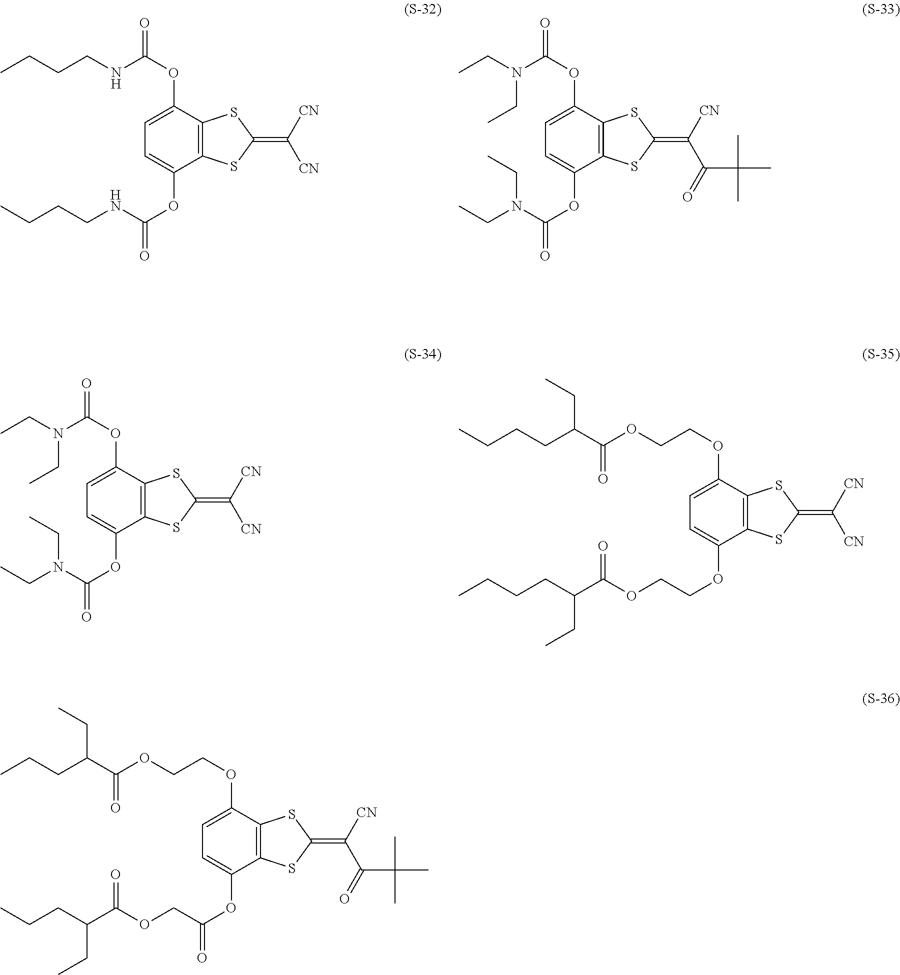 [SMILES: CCCCNC(=O)Oc1ccc(OC(=O)NCCCC)c2c1SC(=C(C#N)C#N)S2 ; CCN(CC)C(=O)Oc1ccc(OC(=O)N(CC)CC)c2c1SC(=C(C#N)C(=O)C(C)(C)C)S2 ; CCN(CC)C(=O)Oc1ccc(OC(=O)N(CC)CC)c2c1SC(=C(C#N)C#N)S2 ; CCCCC(CC)C(=O)OCCOc1ccc(OCCOC(=O)C(CC)CCCC)c2c1SC(=C(C#N)C#N)S2 ; CCCC(CC)C(=O)OCCOc1ccc(OC(=O)COC(=O)C(CC)CCC)c2c1S/C(=C(\C#N)C(=O)C(C)(C)C)S2]

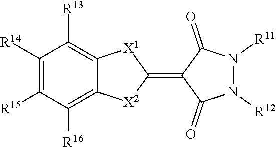

| Compound No. | X¹ | X² | R¹¹ | R¹² | R¹³ | R¹⁴ | R¹⁵ | R¹⁶ |
|---|---|---|---|---|---|---|---|---|
| T-1 | S | S | Me | Me | H | H | H | H |
| T-2 | S | S | Me | Me | H | Me | H | H |
| T-3 | S | S | Me | Me | H | t-Bu | H | H |
| T-4 | S | S | Me | Me | H | Cl | Cl | H |
| T-5 | S | S | Me | Me | H | Cl | H | H |
| T-6 | S | S | Me | Me | H | Br | H | H |
| T-7 | S | S | Me | Me | H | Me | Me | H |
| T-8 | S | S | Me | Me | H | OMe | H | H |
| T-9 | S | S | Me | Me | H | OEt | H | H |
| T-10 | S | S | Me | Me | H | NO₂ | H | H |
| T-11 | S | S | Me | Me | SEt | SEt | SEt | SEt |
| T-12 | S | S | Me | Me | Me | H | H | H |
| T-13 | S | S | Me | Me | NO₂ | H | CN | H |
| T-14 | S | S | Me | Me | NO₂ | H | CF₃ | H |
| T-15 | S | S | Me | Me | NMe₂ | NO₂ | H | CF₃ |
| T-16 | S | S | Me | Me | H | NH₂ | H | H |
| T-17 | S | S | Me | Me | F | F | F | F |
| T-18 | S | S | Me | Me | CO₂Me | H | H | H |
| T-19 | S | S | Me | Me | CO₂H | H | H | H |
| T-20 | S | S | Me | Me | OH | H | H | OH |
| T-21 | S | S | Me | Me | OH | Me | H | OH |
| T-22 | S | S | Me | Me | OH | t-Bu | H | OH |
| T-23 | S | S | Me | Me | OH | OMe | H | OH |
| T-24 | S | S | Me | Me | OMe | H | H | OMe |
| T-25 | S | S | Me | Me | OEt | H | H | OEt |
| T-26 | S | S | Me | Me | Oi-Pr | H | H | Oi-Pr |
| T-27 | S | S | Me | Me | Ot-Bu | H | H | Ot-Bu |
| T-28 | S | S | Me | Me | O(n-Hex) | H | H | O(n-C₆H₁₃₎ |
| T-29 | S | S | Me | Me | OCH₂CH(n-Bu)Et | H | H | OCH₂CH(n-Bu)Et |
| T-30 | S | S | Me | Me | On-C₁₈H₃₇ | H | H | On-C₁₈H₃₇ |
| T-31 | S | S | Me | Me | OAc | H | H | OAc |
| T-32 | S | S | Me | Me | OCOi-Pr | H | H | OCOi-Pr |
| T-33 | S | S | Me | Me | OCOi-Bu | H | H | OCOt-Bu |
| T-34 | S | S | Me | Me | OCOCH(n-Bu)Et | H | H | OCOCH(n-Bu)Et |
| T-35 | S | S | Me | Me | OTs | H | H | OTs |

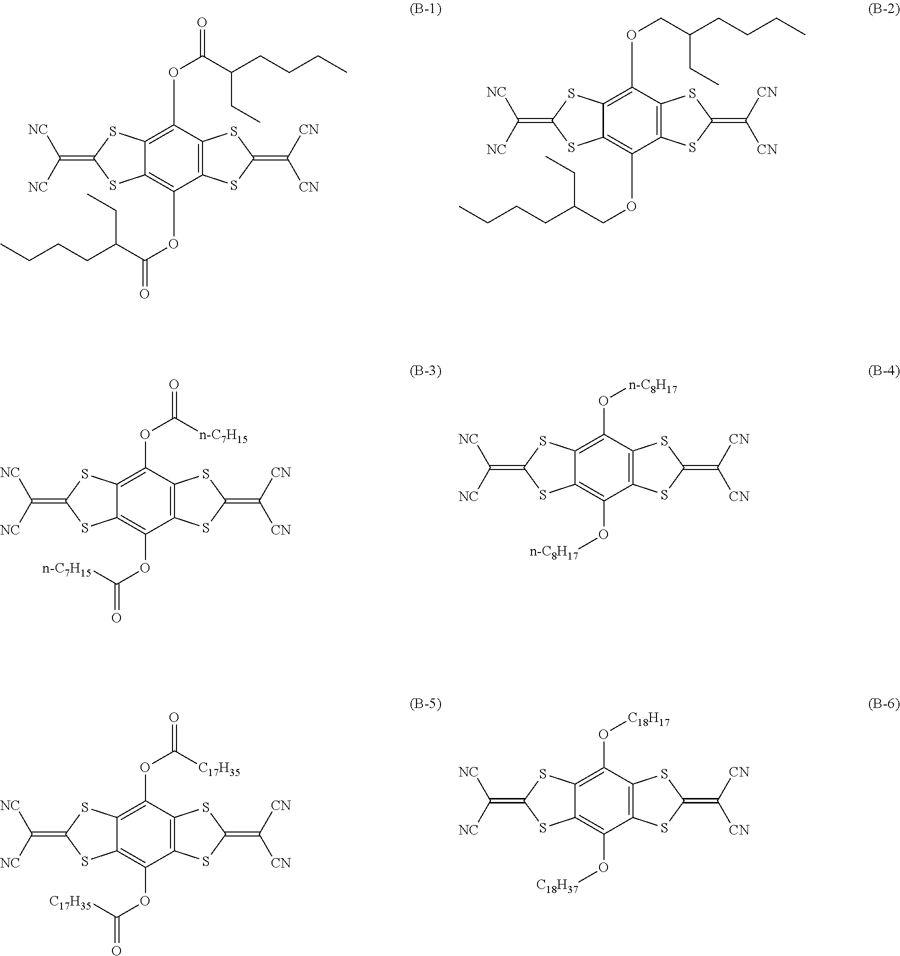

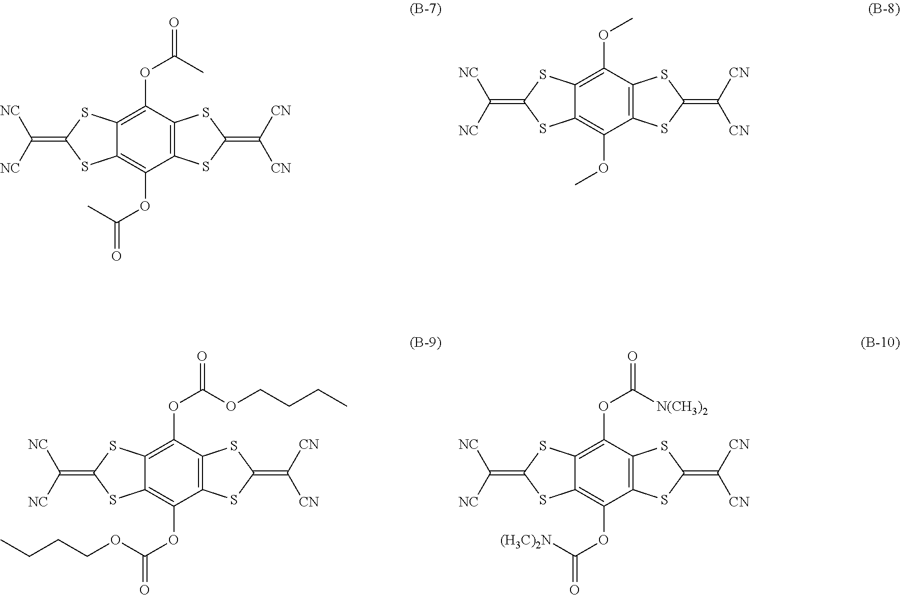

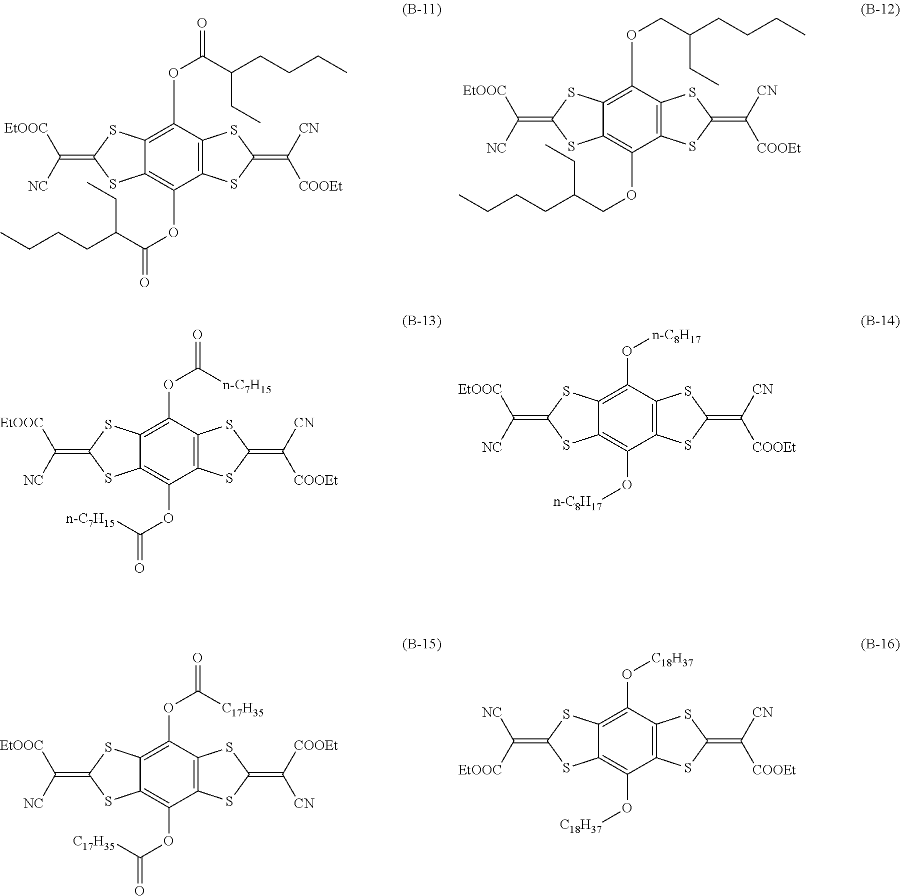

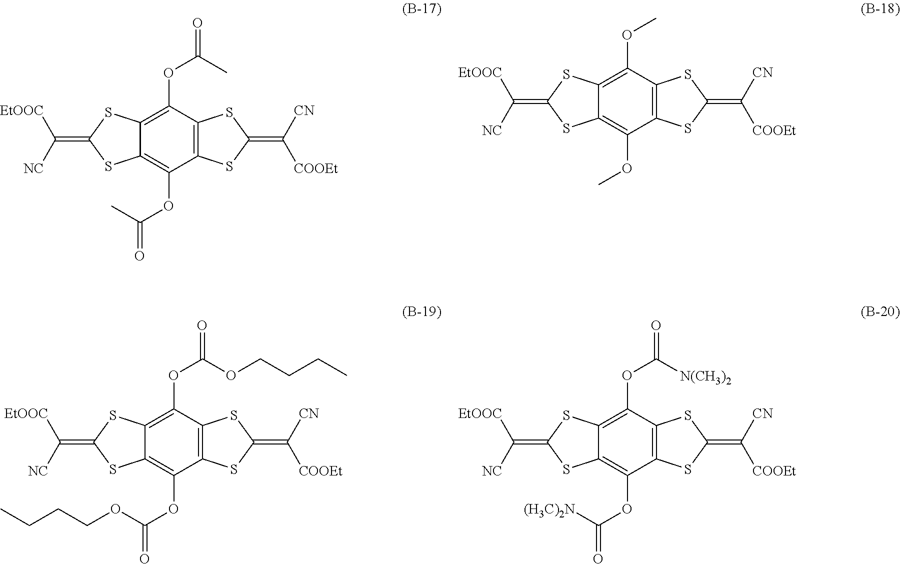

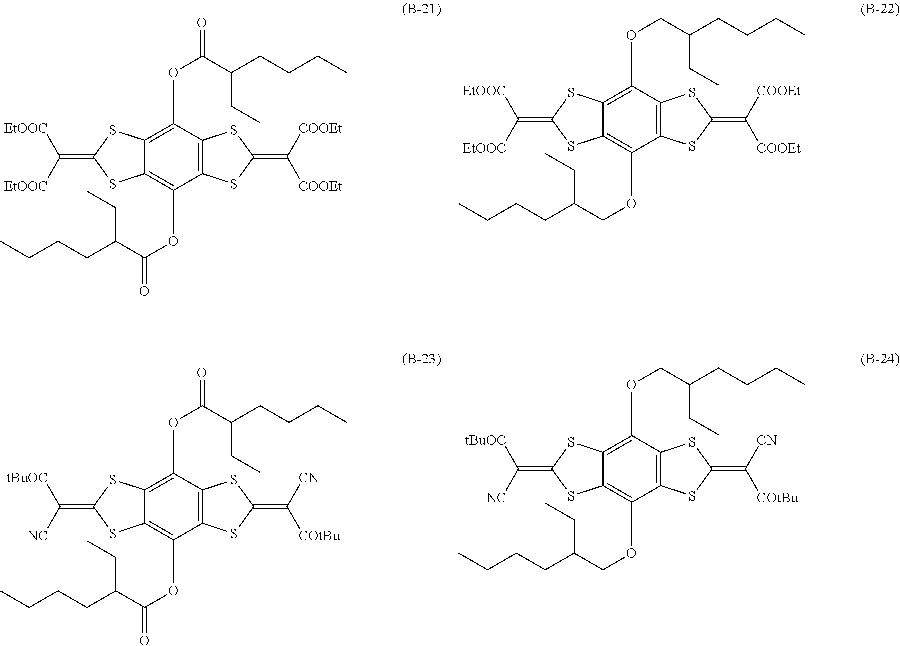

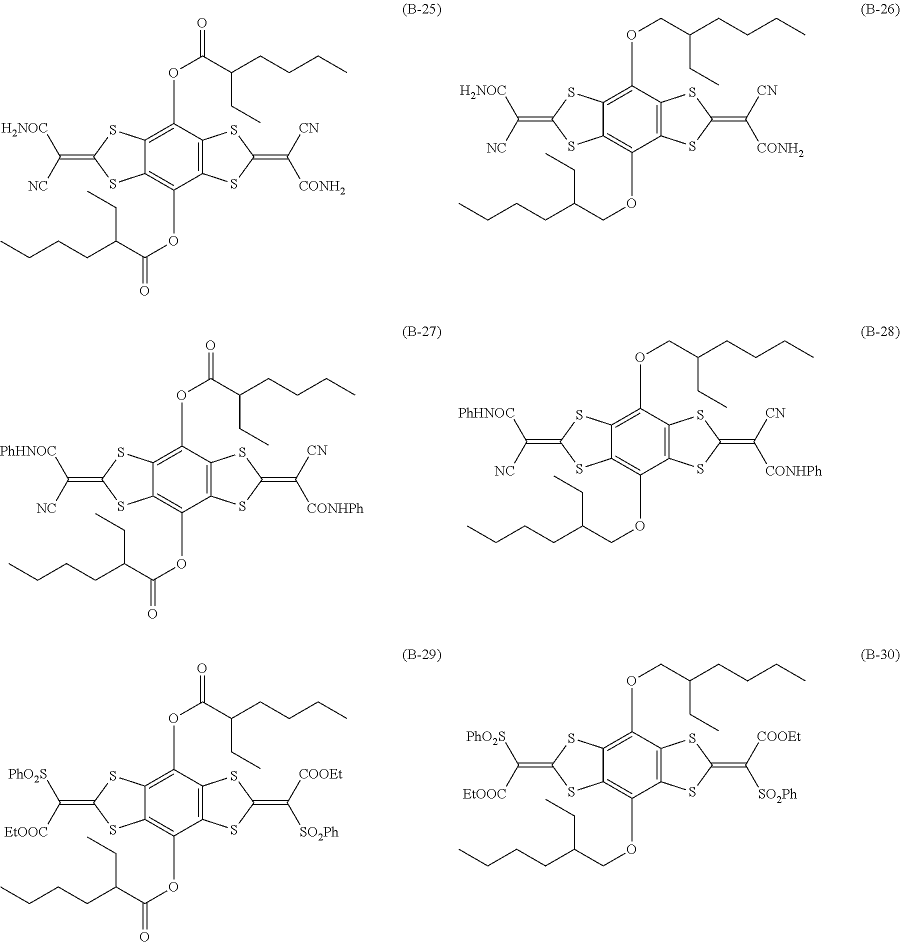

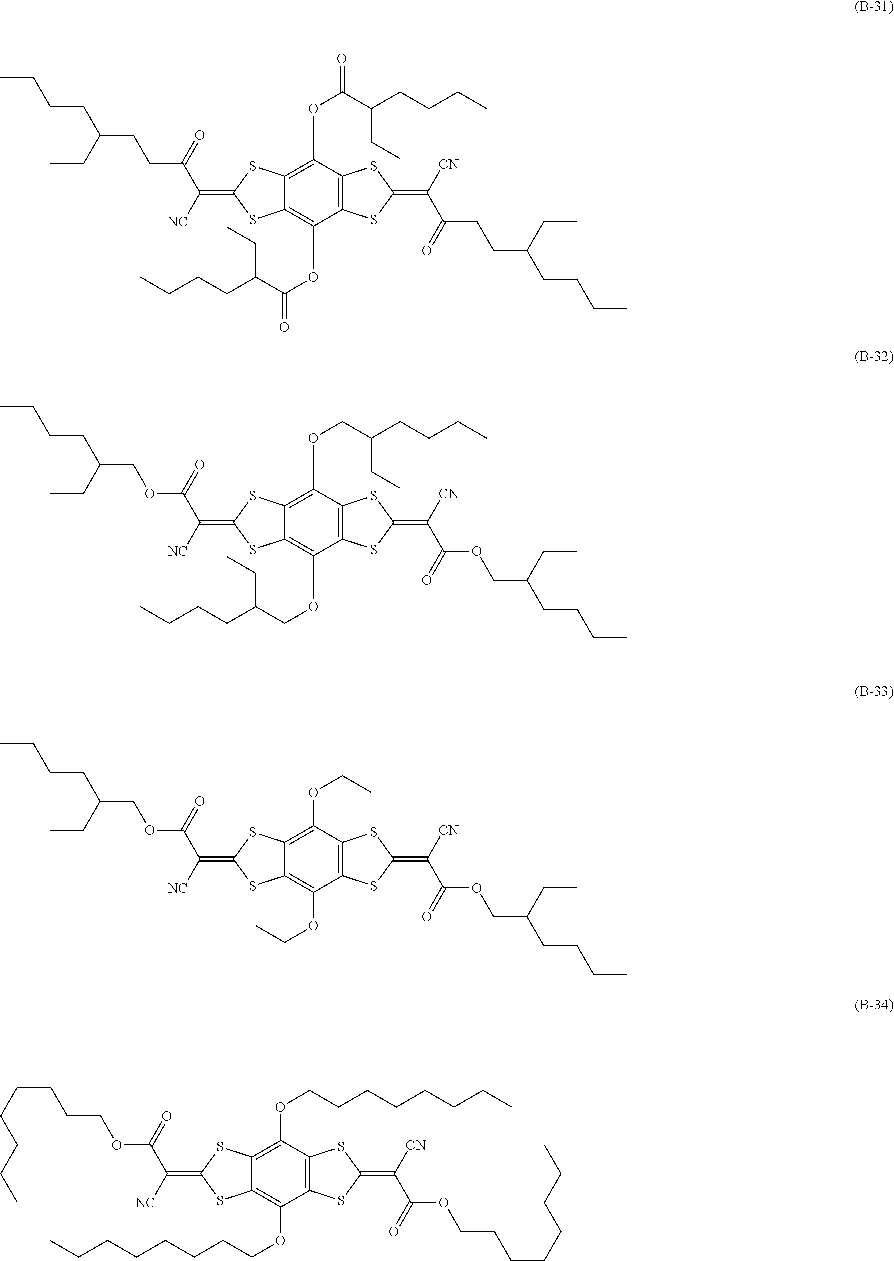

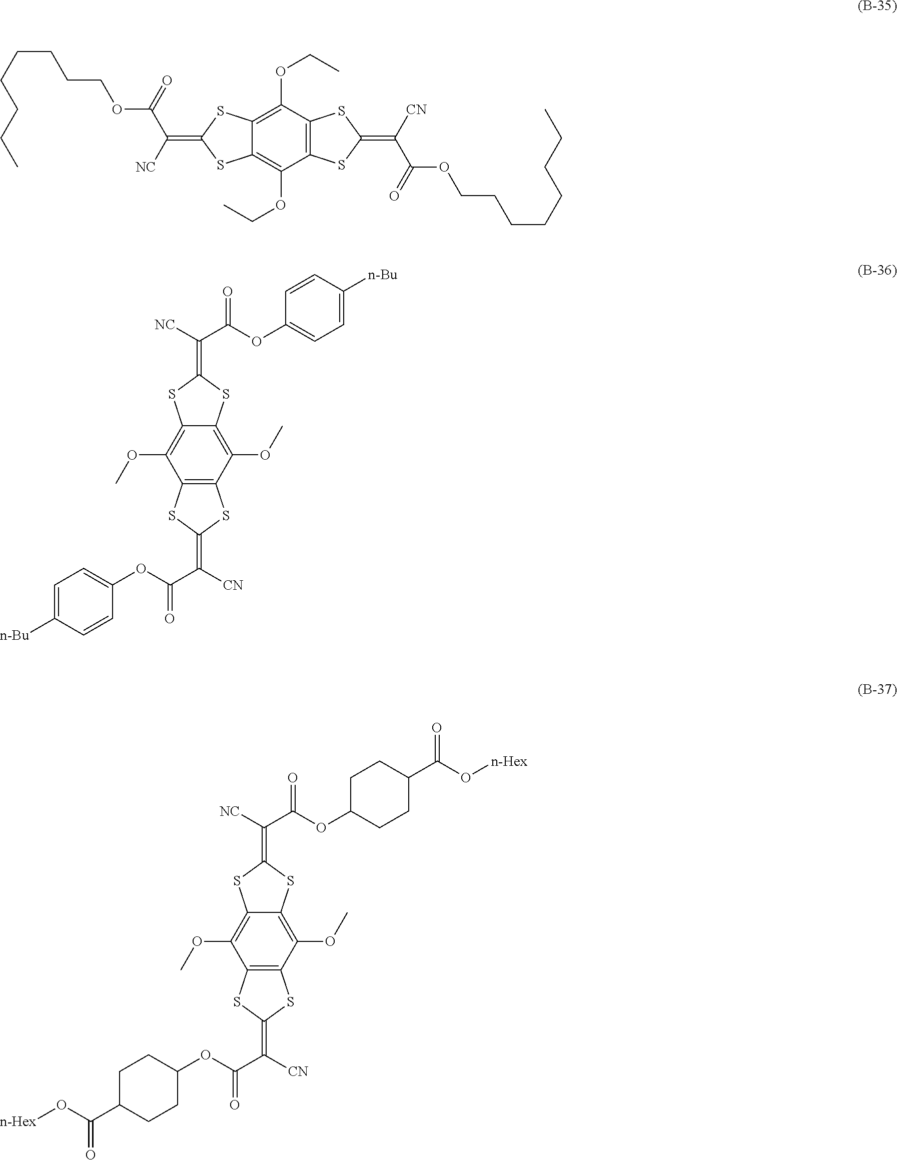

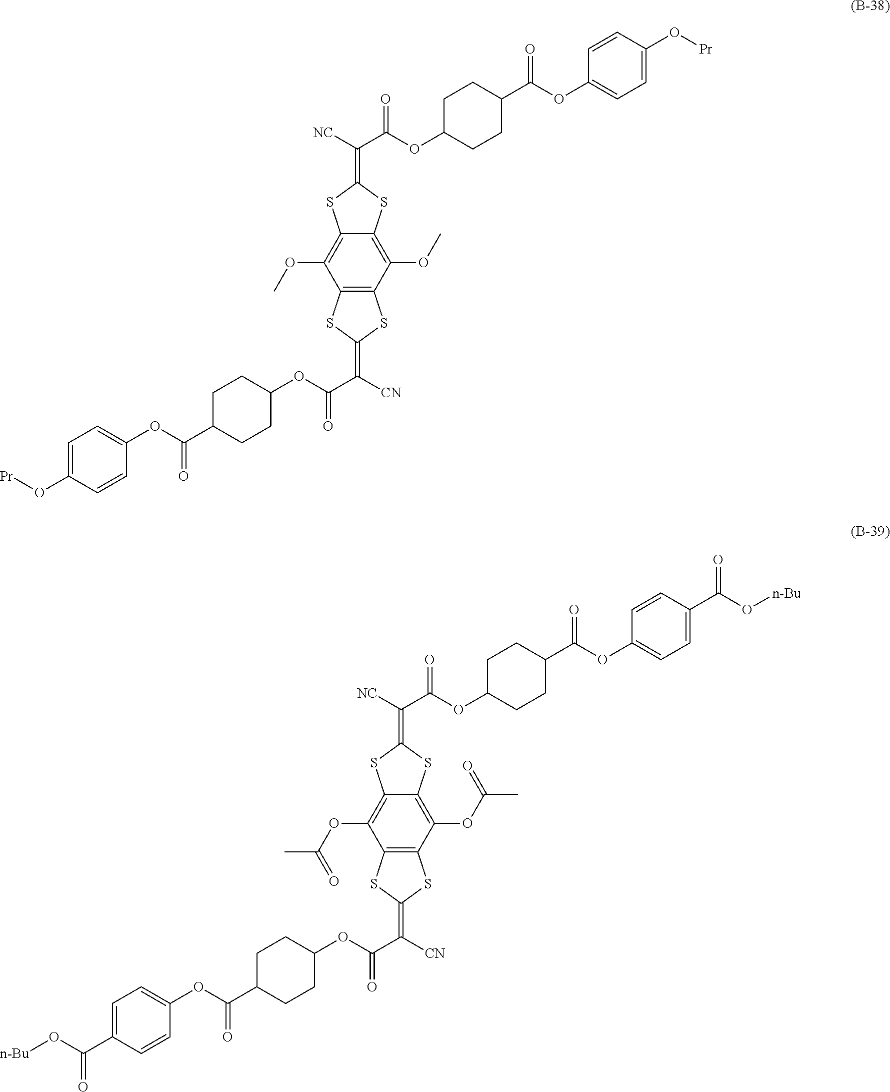

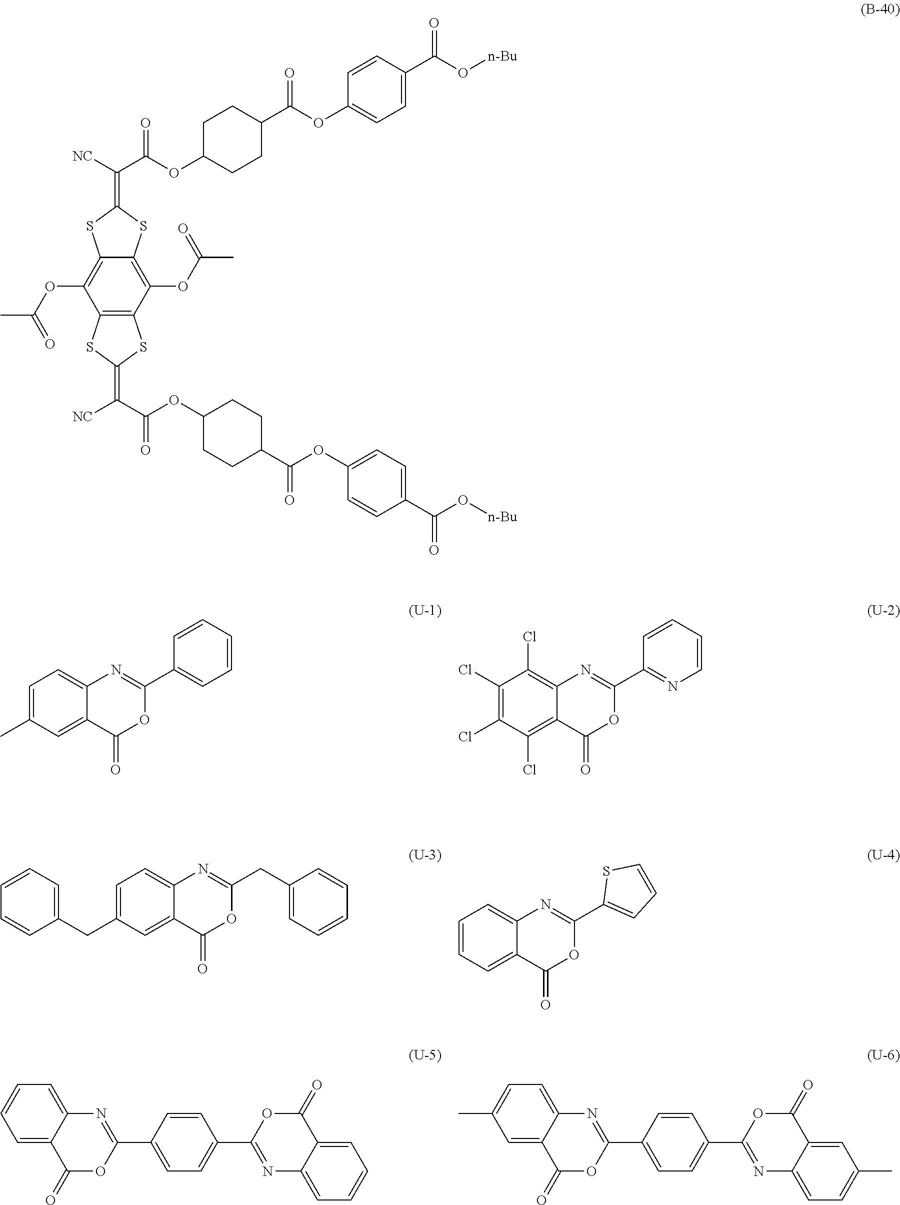

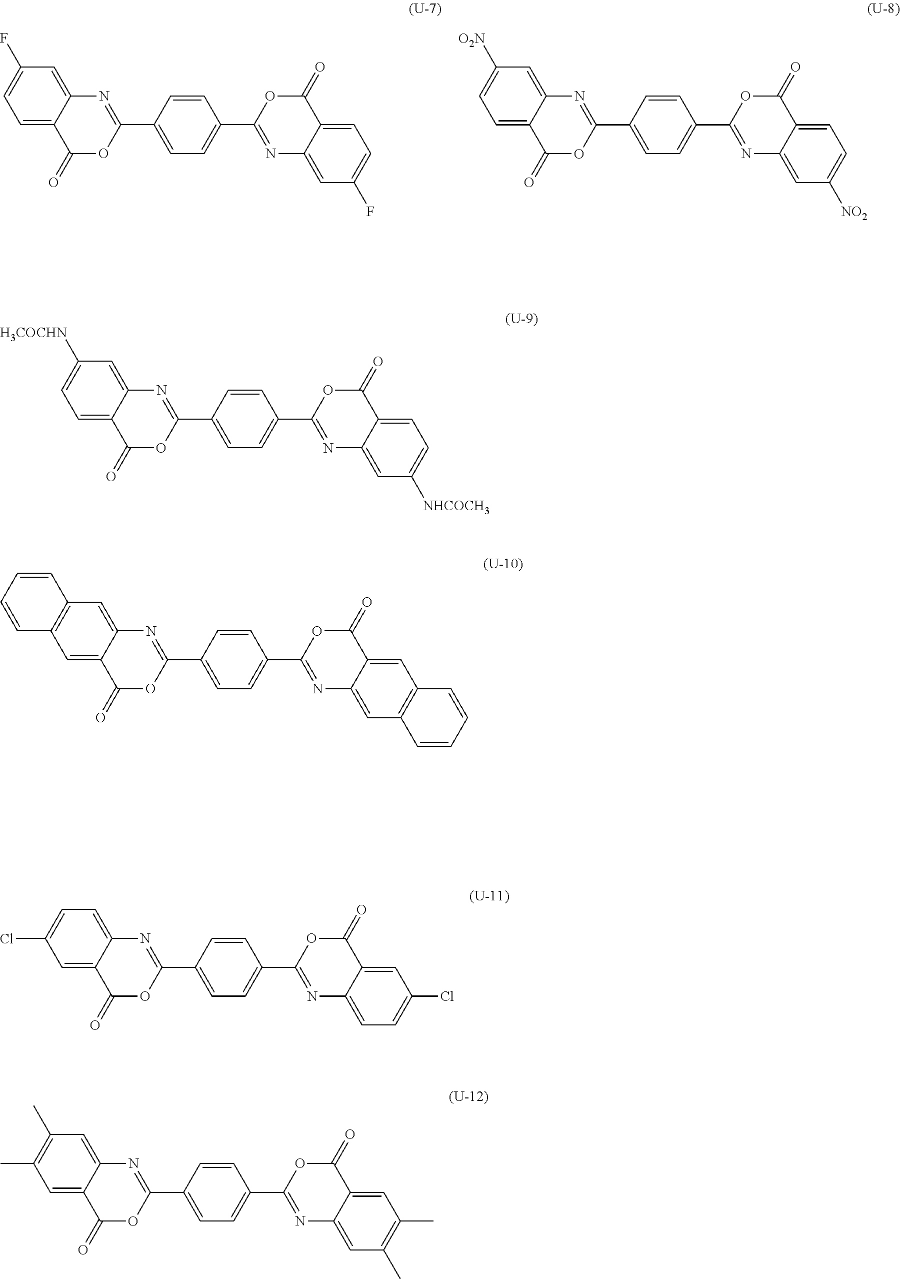

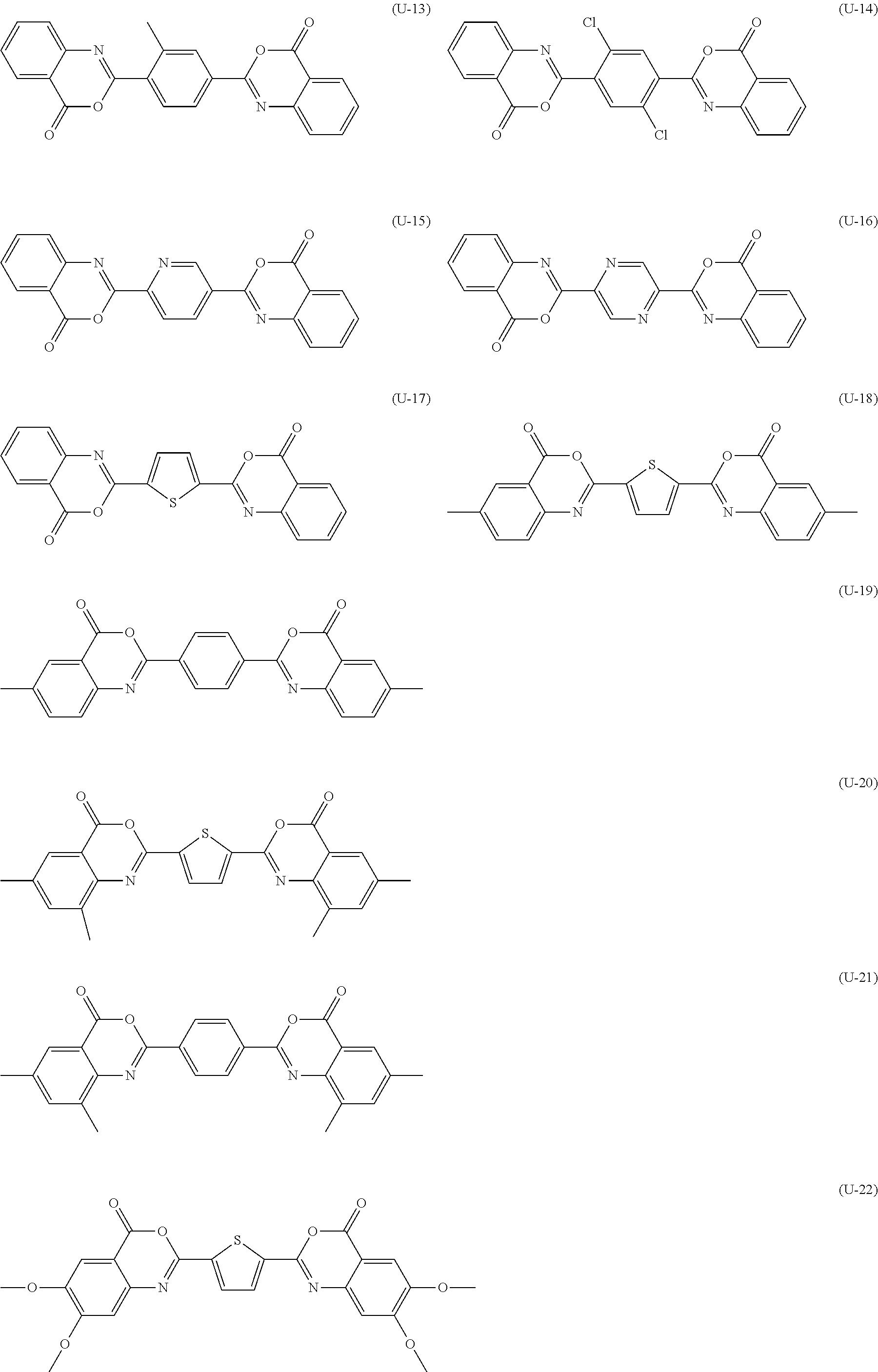

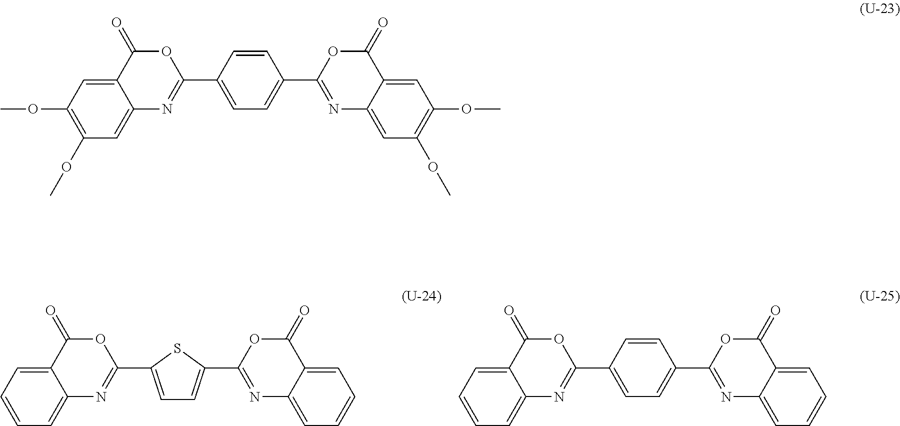

The lens for spectacles of the present disclosure may contain only one kind of the specific compound or may contain two or more kinds thereof.

The content ratio of the ultraviolet absorbing agent A in the lens for spectacles according to the present disclosure is not particularly limited, and, for example, is preferably 0.01 mass % to 1.0 mass %, more preferably 0.01 mass % to 0.5 mass %, and even more preferably 0.01 mass % to 0.1 mass % with respect to the total mass of the resin.

In a case where the content ratio of the ultraviolet absorbing agent A in the lens for spectacles of the present disclosure is in the above range, the compatibility with the resin is satisfactory, and thus the ultraviolet absorbing agent A is hardly precipitated, and a haze hardly occurs. Since the ultraviolet absorbing agent A has a high molar absorption coefficient in the wavelength range of 380 nm to 400 nm (particularly at 400 nm), even in a case where the content ratio in the lens for spectacles of the present disclosure is within the above range, the blue light in the above wavelength range can be blocked in a satisfactory manner.

[Resin Having Refractive Index of 1.65 or More]

The lens for spectacles of the present disclosure contains a resin having a refractive index of 1.65 or more.

The resin is not particularly limited, as long as it is a resin that satisfies physical properties required for the lens for spectacles such as transparency, refractive index, workability, and hardness after curing. The resin may be a thermoplastic resin or a thermosetting resin (for example, a thiourethane resin and an episulfide resin).

From the viewpoint of a high refractive index, the resin is preferably at least one resin selected from the group consisting of a thiourethane resin and an episulfide resin, and more preferably an episulfide resin.

The thiourethane resin and the episulfide resin are widely used as materials for the lens for spectacles having a high refractive index, but have poor compatibility with an ultraviolet absorbing agent (for example, a benzotriazole-based ultraviolet absorbing agent) used in the lens for spectacles in the related art and, particularly, are susceptible to precipitation of the ultraviolet absorbing agent.

Adding the ultraviolet absorbing agent A allows the lens for spectacles of the present disclosure to suppress the precipitation of the ultraviolet absorbing agent, and the absorption characteristics of the ultraviolet absorbing agent A prevent the lens from having a yellowish tint. Therefore, the lens for spectacles of the present disclosure has satisfactory transparency even in a case where the lens contains at least one selected from the group consisting of a thiourethane resin and an episulfide resin as a resin, and a change in tint is hardly recognized in a case where an object is viewed through the lens.

For details of the thiourethane resin and the episulfide resin suitable as the resin of the lens for spectacles of the present disclosure, refer to the disclosure of JP2009-256692A, JP2007-238952A, JP2009-074624A, JP2015-212395A, and JP2016-084381A.

The resin may be a resin formed using a precursor monomer of a commercially available resin.

Examples of commercially available products of the precursor monomer of the resin include MR-7 (registered trademark) (refractive index n=1.67), MR-10 (registered trademark) (refractive index n=1.67), and MR-174 (registered trademark) (refractive index n=1.74) (above trade names, Mitsui Chemicals, Inc.) which are precursor monomers of the thiourethane resin. Further, examples thereof also include LUMIPLUS LPB-1102 (registered trademark) (refractive index n=1.71) [above trade name, Ryoko chemical Co., LTD.].

The lens for spectacles of the present disclosure may contain only one kind of the resin or may contain two or more kinds thereof.

The content ratio of the resin in the lens for spectacles according to the present disclosure is not particularly limited, for example, and is preferably 30 mass % to 99.99 mass %, more preferably 50 mass % to 99.9 mass %, and even more preferably 60 mass % to 99 mass % with respect to the total mass of the lens for spectacles.

In a case where the content ratio of the resin in the lens for spectacles according to the present disclosure is in the above range, it is possible to produce a lightweight and thin lens.

[Other Ultraviolet Absorbing Agent]

The lens for spectacles of the present disclosure may contain a compound (hereinafter, referred to as “ultraviolet absorbing agent B”) having an ultraviolet absorbing ability other than the specific compound described above.

Adding the ultraviolet absorbing agent B allows the lens for spectacles of the present disclosure to block blue light in a wide range of the ultraviolet region.

The ultraviolet absorbing agent B is not particularly limited as long as the ultraviolet absorbing agent B is a known ultraviolet absorbing agent used for the lens for spectacles and is a compound not included in the ultraviolet absorbing agent A described above.

Examples of the ultraviolet absorbing agent B include ultraviolet absorbing agents such as a benzotriazole compound, a triazine compound, a benzophenone compound, a cyanine compound, a dibenzoylmethane compound, a cinnamic acid compound, an acrylate compound, a benzoic acid ester compound, an oxalic acid diamide compound, and a formamidine compound, and from the viewpoint of the blue light-blocking property in a wide range, preferred is at least one selected from a benzotriazole compound or a benzotriazine compound. For details of these ultraviolet absorbing agents, refer to “Monthly Fine Chemicals” May 2004, pages 28 to 38, “New Development of Functional Additives for Polymers” published by Toray Research Center Research Division, (Toray Research Center, 1999) pages 96 to 140, “Development of Polymer Additives And Environmental Measures” edited by Okachi Junichi, (CMC Publishing Co., Ltd., 2003) pages 54 to 64, and “Polymer Deterioration/Discoloring Mechanism and Stabilization Technology Thereof—Know-How Collection” (Technical Information Institute Co., Ltd., 2006) published by Technical Information Institute Co., Ltd., for example.

Since the ultraviolet absorbing agent A represented by the specific compound described above does not absorb light having a wavelength of 350 nm or less, the ultraviolet absorbing agent B is preferably an ultraviolet absorbing agent having a maximum absorption wavelength of 350 nm or less, for example, from the viewpoint of blocking blue light in a wide range of the ultraviolet region.

In the case of containing the ultraviolet absorbing agent B, the lens for spectacles of the present disclosure may contain only one kind of the ultraviolet absorbing agent B or may contain two or more kinds thereof.

In a case where the lens for spectacles of the present disclosure contains the ultraviolet absorbing agent B, the content ratio of the ultraviolet absorbing agent B in the lens for spectacles is appropriately set according to the kind of the selected ultraviolet absorbing agent.

Generally, the content ratio of the ultraviolet absorbing agent B in the lens for spectacles of the present disclosure is preferably 0.01 mass % to 3.0 mass % with respect to the total mass of the resin for one kind of the other ultraviolet absorbing agent.

In a case where the lens for spectacles of the present disclosure contains two or more kinds of the ultraviolet absorbing agents B, the total content ratio of the ultraviolet absorbing agents B in the lens for spectacles of the present disclosure is preferably 0.01 mass % to 3.0 mass % with respect to the total mass of the resin.

In a case where the total content ratio of the ultraviolet absorbing agents B in the lens for spectacles of the present disclosure is in the above range, the occurrence of haze and the yellowish tint are suppressed and the blue light in a wide range of the ultraviolet region can be blocked in a satisfactory manner.

Further, the content ratio (A:B) of the ultraviolet absorbing agent A and the ultraviolet absorbing agent B is preferably 0.1:1 to 1:0.1, more preferably 0.2:1 to 1:0.2, and even more preferably 0.3:1 to 1:0.3 on a mass basis.

[Other Components]

The lens for spectacles of the present disclosure may contain a component other than the component described above (so-called, other additives).

Examples of the other additive include a plasticizer, an antidegradant (for example, an antioxidant, a peroxide decomposer, a radical inhibitor, a metal deactivator, an acid scavenger, and amine), a dye, an internal release agent, and a deodorant.

[Refractive Index]

The refractive index of the lens for spectacles of the present disclosure is 1.65 or more, more preferably 1.67 or more, and even more preferably 1.70 or more.

Further, in a case where the lens for spectacles of the present disclosure has the above refractive index, the thickness of the lens can be reduced, and the reduction in weight of the lens can be easily realized.

The refractive index of the lens for spectacles of the present disclosure can be measured by a refractometer, and it is particularly preferable to use an Abbe refractometer. Specifically, “DR-A1” manufactured by Atago Co., Ltd. can be used as the Abbe refractometer.

It can be determined that the refractive index of the lens is equal to the refractive index of the resin contained in the lens.

[Method of Manufacturing Lens for Spectacles]

A method of manufacturing the lens for spectacles of the present disclosure is not particularly limited, as long as the lens for spectacles of the present disclosure described above can be manufactured.

For example, in a case where the resin contained in the lens for spectacles is a thermoplastic resin, the lens for spectacles of the present disclosure can be manufactured by molding a resin composition containing the resin, a specific compound (ultraviolet absorbing agent A), and optionally another ultraviolet absorbing agent (ultraviolet absorbing agent B) and another additive as optional components into pellets using a melt extruder, and applying a known molding method such as an injection molding method using the obtained pellet-shaped resin composition.

For example, in a case where the resin contained in the lens for spectacles is a thermosetting resin, the lens for spectacles of the present disclosure can be manufactured by preparing a resin composition containing a monomer as a precursor of the resin, a specific compound, a polymerization catalyst (for example, dibutyltin dichloride), and, as necessary, another ultraviolet absorbing agent and another additive as optional components, filling the obtained resin composition into a mold (molding die), and curing the resin composition by heating.

[Spectacles]

The spectacles of the present disclosure comprise the lens for spectacles of the present disclosure described above.

In other words, the spectacles of the present disclosure have a configuration in which the lens for spectacles of the present disclosure is mounted on an appropriate spectacle frame described above.

According to the spectacles of the present disclosure, the lens for spectacles mounted on the spectacles can block blue light in the wavelength range of at least 380 nm to 400 nm. Therefore, it can be expected that wearing the spectacles of the present disclosure reduces eye fatigue caused by blue light in a case where an operation of viewing a display of an image display device or the like is performed for a long period of time.

Further, according to the spectacles of the present disclosure, a change in tint is hardly recognized in a case where an object is viewed through the lens.

### EXAMPLES

Hereinafter, the present invention will be described more specifically with reference to the Examples, but the present invention is not limited to the following Examples without departing from the gist thereof.

[Measurement of Absorption Spectrum]

The absorption spectra of the specific compounds and comparative compounds shown in Table 1 below in chloroform solution were measured. As the measuring instrument, a spectrophotometer (Model number: UV 3150) of Shimadzu Corporation was used.

Table 1 shows the ratios of the absorbances at the wavelength of 400 nm and at the wavelength of 410 nm in a case where the absorbance at the maximum absorption wavelength of each compound is 1.0, and the proportion between the absorbance ratios.

In Table 1, the numerical values (Ratio^{*1} and Ratio^{*2}) shown in the columns “Ratio of absorbance at 400 nm^{*1}” and “Ratio of absorbance at 410 nm^{*2}” are values calculated by Formulae A and B from the measured absorbances of each compound. The “proportion between absorbance ratios” is a value calculated by dividing the value of ratio^{*1} by the value of ratio^{*2}.

Ratio^{*1}=(absorbance at 400 nm)/(absorbance at maximum absorption wavelength) Formula A

Ratio^{*2}=(absorbance 410 nm)/(absorbance at maximum absorption wavelength) Formula B

TABLE 1

| | Ratio of | Ratio of | Ratio between | |
|---|---|---|---|---|
| | absorbance | absorbance | absorbance ratios | |
| Compound | at 400 nm^{*1} | at 410 nm^{*2} | (Ratio^{*1}/Ratio^{*2}) | Remarks |
| I-1 | 0.41 | 0.047 | 8.72 | specific compound |
| I-2 | 0.41 | 0.046 | 8.91 | specific compound |
| I-3 | 0.43 | 0.045 | 9.56 | specific compound |
| I-7 | 0.41 | 0.046 | 8.91 | specific compound |
| I-23 | 0.43 | 0.032 | 13.43 | specific compound |
| S-1 | 0.164 | 0.012 | 13.67 | specific compound |
| S-18 | 0.170 | 0.015 | 11.33 | specific compound |
| S-36 | 0.182 | 0.020 | 9.1 | specific compound |
| T-29 | 0.103 | 0.011 | 9.36 | specific compound |
| B-2 | 0.45 | 0.060 | 7.5 | specific compound |
| B-23 | 0.43 | 0.065 | 6.62 | specific compound |
| U-17 | 0.49 | 0.074 | 6.62 | specific compound |
| H-1 | 0 | 0 | 0 | comparative compound |
| H-2 | 0.047 | 0.002 | 23.5 | comparative compound |
| H-3 | 0.042 | 0.004 | 10.5 | comparative compound |

Each compound described as “specific compound” in the remarks column in Table 1 corresponds to the compound listed above as an example compound of the specific compound. The structures of comparative compound (H-1), comparative compound (H-2), and comparative compound (H-3) are shown below.

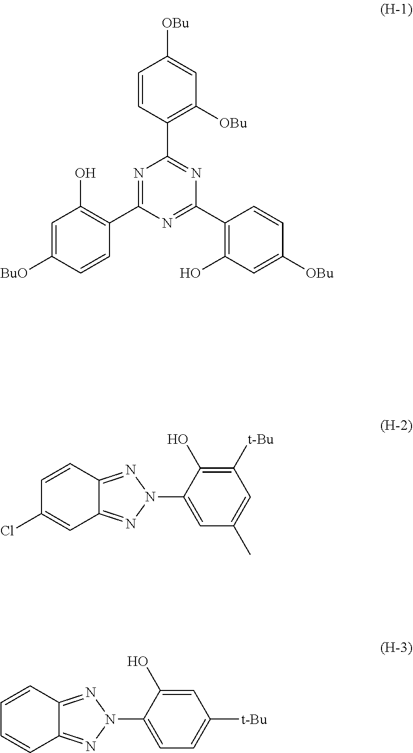

As shown in Table 1, it can be seen that the specific compound (ultraviolet absorbing agent A) has, in a case where an absorbance at a maximum absorption wavelength is 1.0, an absorbance ratio at 410 nm of 0.10 or less and an absorbance ratio at 400 nm of 0.10 or more, where a proportion of the absorbance ratio at 400 nm to the absorbance ratio at 410 nm is 5.0 or more.

On the other hand, it can be seen that among the comparative compounds, the comparative compounds H-2 and H-3 have, in a case where an absorbance at a maximum absorption wavelength is 1.0, an absorbance at 410 nm of 0.10 or less, but the absorbance at 400 nm thereof is not 0.10 or more, and therefore these do not fall under the category of specific compounds, and the comparative compound H-1 also does not fall under the category of specific compounds as well.

Next, the color values (=molar absorption coefficient/molecular weight) of the specific compounds (S-6, T-29, B-2, and B-23) used in Examples and the comparative compounds (H-1, H-2, and H-3) were calculated. Results thereof are as shown in Table 2.

TABLE 2

| Compound | Color value | Remarks |
|---|---|---|
| S-6 | 48 | specific compound |
| T-29 | 60 | specific compound |
| B-2 | 150 | specific compound |
| B-23 | 142 | specific compound |
| H-1 | 122 | comparative compound |
| H-2 | 52 | comparative compound |
| H-3 | 54 | comparative compound |

As shown in Table 2, many of the specific compounds had higher color values than the comparative compounds, and particularly B-2 and B-23 showed high color values. This demonstrates that the specific compound can more efficiently absorb blue light even with the same addition amount.

In particular, in a lens for spectacles having a high refractive index, the use of a compound having a higher color value is advantageous in that the thickness can be reduced (lightweight). In this case, it can be seen that the specific compound capable of efficiently absorbing blue light with a small addition amount is useful for providing a lens for spectacles having a small haze and high transparency due to the small addition amount.

[Production of Lens]

### Example 1-1

100 parts by mass of MR-7 (registered trademark) [trade name, refractive index: 1.67, Mitsui Chemicals, Inc.] as a precursor monomer of a thiourethane resin, 0.1 parts by mass of the specific compound 1-2 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-2

100 parts by mass of MR-7 (registered trademark) [trade name, refractive index: 1.67, Mitsui Chemicals, Inc.] as a precursor monomer of a thiourethane resin, 0.1 parts by mass of the specific compound 1-3 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-3

100 parts by mass of MR-10 (registered trademark) [trade name, refractive index: 1.67, Mitsui Chemicals, Inc.] as a precursor monomer of a thiourethane resin, 0.1 parts by mass of the specific compound 1-7 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-4

100 parts by mass of MR-174 (registered trademark) [trade name, refractive index: 1.74, Mitsui Chemicals, Inc.] as a precursor monomer of a thiourethane resin, 0.1 parts by mass of the specific compound 1-2 described above, 0.1 parts by mass of the compound H-3 (a compound having the above structure) as another ultraviolet absorbing agent (ultraviolet absorbing agent B), and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-5

100 parts by mass of MR-7 (registered trademark) [trade name, refractive index: 1.67, Mitsui Chemicals, Inc.] as a precursor monomer of a thiourethane resin, 0.1 parts by mass of the specific compound 1-23 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-6

100 parts by mass of MR-7 (registered trademark) [trade name, refractive index: 1.67, Mitsui Chemicals, Inc.] as a precursor monomer of a thiourethane resin, 0.1 parts by mass of the specific compound S-1 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-7

100 parts by mass of MR-7 (registered trademark) [trade name, refractive index: 1.67, Mitsui Chemicals, Inc.] as a precursor monomer of a thiourethane resin, 0.1 parts by mass of the specific compound S-18 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-8

100 parts by mass of MR-7 (registered trademark) [trade name, refractive index: 1.67, Mitsui Chemicals, Inc.] as a precursor monomer of a thiourethane resin, 0.1 parts by mass of the specific compound S-36 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-9

100 parts by mass of MR-7 (registered trademark) [trade name, refractive index: 1.67, Mitsui Chemicals, Inc.] as a precursor monomer of a thiourethane resin, 0.1 parts by mass of the specific compound T-29 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-10

100 parts by mass of MR-7 (registered trademark) [trade name, refractive index: 1.67, Mitsui Chemicals, Inc.] as a precursor monomer of a thiourethane resin, 0.1 parts by mass of the specific compound U-17 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-11

100 parts by mass of bis-β-epithiopropyl disulfide and 10 parts by mass of 4,8-dimercaptomethyl-1,11-dimercapto-3,6,9-trithiaundecane as precursors of an episulfide resin (refractive index n=1.70), 0.1 parts by mass of the specific compound 1-2 described above, and 0.01 parts by mass of N,N-dimethylcyclohexylamine as a polymerization catalyst were mixed using a blender, and the obtained mixture was filled into a mold (that is, a molding die), was left at 30° C. for eight hours, and then was cured at 100° C. for 10 hours, such that a lens for spectacles having a thickness of 2 mm was produced. Visual observation confirmed that the produced lens for spectacles was transparent.

### Example 1-12

100 parts by mass of MR-7 (registered trademark) [trade name, refractive index: 1.67, Mitsui Chemicals, Inc.] as a precursor monomer of a thiourethane resin, 0.1 parts by mass of the specific compound 1-2 described above, 0.02 parts by mass of the compound H-1 (a compound having the above structure) as another ultraviolet absorbing agent B, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Examples 1-13

100 parts by mass of MR-7 (registered trademark) [trade name, refractive index: 1.67, Mitsui Chemicals, Inc.] as a precursor monomer of a thiourethane resin, 0.1 parts by mass of the specific compound 1-2 described above, 0.02 parts by mass of the compound H-2 (a compound having the above structure) as another ultraviolet absorbing agent B, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-14

100 parts by mass of MR-7 (registered trademark) [trade name, refractive index: 1.67, Mitsui Chemicals, Inc.] as a precursor monomer of a thiourethane resin, 0.1 parts by mass of the specific compound B-2 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 1-15

100 parts by mass of MR-7 (registered trademark) [trade name, refractive index: 1.67, Mitsui Chemicals, Inc.] as a precursor monomer of a thiourethane resin, 0.1 parts by mass of the specific compound B-23 described above, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Comparative Example 1-1

100 parts by mass of MR-7 (registered trademark) [trade name, refractive index: 1.67, Mitsui Chemicals, Inc.] as a precursor monomer of a thiourethane resin, 0.1 parts by mass of the compound H-1, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Comparative Example 1-2

100 parts by mass of MR-7 (registered trademark) [trade name, refractive index: 1.67, Mitsui Chemicals, Inc.] as a precursor monomer of a thiourethane resin, 0.1 parts by mass of the compound H-2, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Comparative Example 1-3

100 parts by mass of MR-7 (registered trademark) [trade name, refractive index: 1.67, Mitsui Chemicals, Inc.] as a precursor monomer of a thiourethane resin, 1.0 parts by mass of the compound H-2, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Comparative Example 1-4

100 parts by mass of MR-7 (registered trademark) [trade name, refractive index: 1.67, Mitsui Chemicals, Inc.] as a precursor monomer of a thiourethane resin, 0.1 parts by mass of the compound H-3, and 0.01 parts by mass of dibutyltin dichloride as a polymerization catalyst were mixed so as to obtain a resin composition. The obtained resin composition was filled into a mold (that is, a molding die) and then was heated at 130° C. for two hours to be cured, such that a lens for spectacles having a thickness of 2 mm was produced. Visual observation confirmed that the produced lens for spectacles was transparent.

### Example 2-1

A lens for spectacles was produced in the same manner as in Example 1-1, except that the amount of the specific compound 1-2 was changed from 0.1 parts by mass to 0.2 parts by mass, and the thickness of the lens was changed to 1 mm. Visual observation confirmed that the produced lens for spectacles was transparent.

### Examples 2-1 to 2-3, 2-5 to 2-12, 2-15 and 2-16, and Comparative Examples 2-1 to 2-4

Lenses for spectacles were produced in the same manner as in Example 2-1, except that the kind of the specific compound or the comparative compound or the kind of the resin was changed to those shown in Table 5 or 6.

Visual observation confirmed that each of the produced lenses for spectacles was transparent.

### Examples 2-4, and 2-13 to 2-14

Lenses for spectacles were produced in the same manner as in Example 2-1, except that 0.2 parts by mass of the ultraviolet absorbing agent B shown in Table 5 or 6 was further added.

Visual observation confirmed that each of the produced lenses for spectacles was transparent.

[Production of Spectacles]

Each of the lenses for spectacles of Examples and Comparative Examples described above was mounted on a spectacle frame so as to produce spectacles.

[Evaluation]

1. Transmittance

For each of the lenses for spectacles of Examples and Comparative Examples, the transmittance at the wavelength of 400 nm was measured immediately after production and after aging in a wet heat environment. As the measuring instrument, a spectrophotometer (Model number: UV 3150) of Shimadzu Corporation was used. The lower the measured transmittance value, the better the blue light-blocking property in the wavelength of 400 nm is.

The conditions of wet heat aging were temperature: 85° C., humidity: 85% RH, period: 300 hours.

Results thereof are as shown in Tables 3 to 6.

2. Haze

For each of the lenses for spectacles of Examples and Comparative Examples, the haze was measured immediately after production and after aging in a wet heat environment. The conditions of wet heat aging are the same as the conditions applied in the measurement of “1. Transmittance” above.

As the measuring instrument, a haze meter (Model number: NDH 7000) of Nippon Denshoku Industries Co., Ltd. was used. The lower the measured haze value, the better the transparency of the lens for spectacles. Results thereof are as shown in Tables 3 to 6.

3. Light Resistance

The light resistance of each of the lenses for spectacles of Examples and Comparative Examples was evaluated.

First, the transmittance of the lens for spectacles at the wavelength of 400 nm was measured by using a spectrophotometer (Model number: UV 3150) of Shimadzu Corporation.

Subsequently, by using a super accelerated weather fastness tester [Product name: EYE SUPER UV TESTER, Iwasaki Electric Co., Ltd.], the lens for spectacles was irradiated with the light of a metal halide lamp (cut about 290 nm or less), under the conditions of the illuminance of 90 mW/cm², a temperature of 63° C., and the relative humidity of 50%, for 60 hours. After the light irradiation, the transmittance of the lens for spectacles at the wavelength of 400 mu was measured with a spectrophotometer (model number: UV 3150) of Shimadzu Corporation in the same manner as above.

The width of the change in transmittance at the wavelength of 400 nm before and after light irradiation was calculated, and in a case where the width of change was less than 5%, the light resistance was evaluated to be “particularly satisfactory”, in a case where the width of change was from 5% to less than 10%, the light resistance was evaluated to be “satisfactory”, and in a case where the width of change was 10% or more, the light resistance was evaluated to be “poor”. Results thereof are as shown in Tables 3 to 6.

The light resistance is an index for maintaining the satisfactory blocking property of blue light over a long period of time by suppressing the decomposition, precipitation, etc., of the ultraviolet absorbing agent A or the like contained in the lens for spectacles even in a case where the lens for spectacles is exposed to ultraviolet rays for a long period of time.

4. Yellowish Tint

The lens for spectacles produced in each of Examples and Comparative Examples was placed on white paper. One evaluation monitor was asked to visually observe the lens for spectacles on paper and evaluate whether the lens for spectacles had a yellowish tint. Results thereof are as shown in Tables 3 to 6.

5. Refractive Index of Lens

The refractive index of the lens for spectacles produced in each of Examples and Comparative Examples was measured.

As the measuring instrument an Abbe refractometer “DR-A1” manufactured by Atago Co., Ltd. was used. Results thereof are as shown in Tables 3 to 6.

6. Eye Fatigue

Two evaluation monitors were asked to wear the produced spectacles, and evaluate whether eye fatigue was felt after three hours of continuous viewing of the display of the image display device was evaluated.

As a result, both of the two evaluation monitors wearing the spectacles comprising the lens for spectacles of each of Examples evaluated that eye fatigue was not felt.

On the other hand, both of the two evaluation monitors wearing with the spectacles comprising the lens for spectacles of each of Comparative Examples evaluated that eye fatigue was felt.

The lens for spectacles of each of Examples mounted on the spectacles, as is clear from the evaluation of the transmittance, have better blue light-blocking property than the lens for spectacles of each of Comparative Examples, as shown in the transmittance evaluation, and thus can effectively suppress the eye fatigue caused by blue light.

7. Change in Tint

Two evaluation monitors were asked to wear the produced spectacles, and an image displayed on the display of the image display device was viewed. Then, in a case where an image was viewed through the lens for spectacles, whether a change in tint was recognized before and after wearing the spectacles was evaluated.

As a result, both of the two evaluation monitors wearing the spectacles comprising the lenses for spectacles of each of Examples evaluated that almost no change in tint was recognized.

On the other hand, both of the two evaluation monitors wearing the spectacles comprising the lenses for spectacles of each of Comparative Examples evaluated that a change in tint was recognized.

TABLE 3

| | | | | Ultra- | | | | | | | | | | |
|---|---|---|---|---|---|---|---|---|---|---|---|---|---|---|
| | Ultraviolet | | | violet | | | | | Evaluation | | | | | |
| | absorbing | Resin | | absorb- | Lens | Absorbance | | | Initial | | After wet | | | |
| | agent A or | | Re- | ing | re- | Ratio^{*1} | Ratio^{*2} | Ratio | performance | | heat aging | | | Yellow- |
| | Comparative | | flective | agent | flective | (400 | (410 | (Ratio^{*1}/ | Trans- | | Trans- | | Light | ish |
| | compound | Kind | index | B | index | nm) | nm) | Ratio^{*2}) | mittance | Haze | mittance | Haze | resistance | tint |
| Ex- | specific | urethane | 1.67 | — | 1.67 | 0.41 | 0.046 | 8.91 | 0.02 | 0.1 | 0.02 | 0.1 | particularly | none |
| ample | compound | resin | | | | | | | | | | | satisfactory | |
| 1-1 | I-2 | (material: | | | | | | | | | | | | |
| | | MR-7) | | | | | | | | | | | | |
| Ex- | specific | urethane | 1.67 | — | 1.67 | 0.43 | 0.045 | 9.56 | 0.03 | 0.1 | 0.03 | 0.1 | particularly | none |
| ample | compound | resin | | | | | | | | | | | satisfactory | |
| 1-2 | I-3 | (material: | | | | | | | | | | | | |
| | | MR-7) | | | | | | | | | | | | |
| Ex- | specific | urethane | 1.67 | — | 1.67 | 0.41 | 0.046 | 8.91 | 0.02 | 0.1 | 0.02 | 0.1 | particularly | none |
| ample | compound | resin | | | | | | | | | | | satisfactory | |
| 1-3 | I-7 | (material: | | | | | | | | | | | | |
| | | MR-10) | | | | | | | | | | | | |
| Ex- | specific | urethane | 1.74 | H-3 | 1.74 | 0.41 | 0.046 | 8.91 | 0.01 | 0.1 | 0.01 | 0.2 | particularly | none |
| ample | compound | resin | | | | | | | | | | | satisfactory | |
| 1-4 | I-2 | (material: | | | | | | | | | | | | |
| | | MR-174) | | | | | | | | | | | | |
| Ex- | specific | urethane | 1.67 | — | 1.67 | 0.43 | 0.032 | 13.43 | 0.02 | 0.1 | 0.02 | 0.1 | particularly | none |
| ample | compound | resin | | | | | | | | | | | satisfactory | |
| 1-5 | I-23 | (material: | | | | | | | | | | | | |
| | | MR-7) | | | | | | | | | | | | |
| Ex- | specific | urethane | 1.67 | — | 1.67 | 0.164 | 0.012 | 13.67 | 0.01 | 0.1 | 0.01 | 0.1 | particularly | none |
| ample | compound | resin | | | | | | | | | | | satisfactory | |
| 1-6 | S-1 | (material: | | | | | | | | | | | | |
| | | MR-7) | | | | | | | | | | | | |
| Ex- | specific | urethane | 1.67 | — | 1.67 | 0.170 | 0.015 | 11.33 | 0.01 | 0.1 | 0.02 | 0.2 | particularly | none |
| ample | compound | resin | | | | | | | | | | | satisfactory | |
| 1-7 | S-18 | (material: | | | | | | | | | | | | |
| | | MR-7) | | | | | | | | | | | | |
| Ex- | specific | urethane | 1.67 | — | 1.67 | 0.182 | 0.020 | 9.1 | 0.01 | 0.1 | 0.01 | 0.1 | particularly | none |
| ample | compound | resin | | | | | | | | | | | satisfactory | |
| 1-8 | S-36 | (material: | | | | | | | | | | | | |
| | | MR-7) | | | | | | | | | | | | |
| Ex- | specific | urethane | 1.67 | — | 1.67 | 0.103 | 0.011 | 9.36 | 0.01 | 0.1 | 0.01 | 0.1 | particularly | none |
| ample | compound | resin | | | | | | | | | | | satisfactory | |
| 1-9 | T-29 | (material: | | | | | | | | | | | | |
| | | MR-7) | | | | | | | | | | | | |

TABLE 4

| | | | | Ultra- | | | | | | | | | | |
|---|---|---|---|---|---|---|---|---|---|---|---|---|---|---|
| | Ultraviolet | | | violet | | | | | Evaluation | | | | | |
| | absorbing | Resin | | absorb- | Lens | Absorbance | | | Initial | | After wet | | | |
| | agent A or | | Re- | ing | re- | Ratio^{*1} | Ratio^{*2} | Ratio | performance | | heat aging | | | Yellow- |
| | Comparative | | flective | agent | flective | (400 | (410 | (Ratio^{*1}/ | Trans- | | Trans- | | Light | ish |
| | compound | Kind | index | B | index | nm) | nm) | Ratio^{*2}) | mittance | Haze | mittance | Haze | resistance | tint |
| Ex- | specific | urethane | 1.67 | — | 1.67 | 0.49 | 0.074 | 6.62 | 0.03 | 0.2 | 0.04 | 0.3 | particularly | none |
| ample | compound | resin | | | | | | | | | | | satisfactory | |
| 1-10 | U-17 | (material: | | | | | | | | | | | | |
| | | MR-7) | | | | | | | | | | | | |
| Ex- | specific | episulfide | 1.70 | — | 1.70 | 0.41 | 0.046 | 8.91 | 0.02 | 0.1 | 0.04 | 0.2 | satisfactory | none |
| ample | compound | resin | | | | | | | | | | | | |
| 1-11 | I-2 | | | | | | | | | | | | | |
| Ex- | specific | urethane | 1.67 | H-1 | 1.67 | 0.41 | 0.046 | 8.91 | 0.02 | 0.3 | 0.03 | 0.3 | particularly | none |
| ample | compound | resin | | | | | | | | | | | satisfactory | |
| 1-12 | I-2 | (material: | | | | | | | | | | | | |
| | | MR-7) | | | | | | | | | | | | |
| Ex- | specific | urethane | 1.74 | H-2 | 1.67 | 0.41 | 0.046 | 8.91 | 0.02 | 0.2 | 0.01 | 0.2 | particularly | none |
| ample | compound | resin | | | | | | | | | | | satisfactory | |
| 1-13 | I-2 | (material: | | | | | | | | | | | | |
| | | MR-7) | | | | | | | | | | | | |
| Ex- | specific | urethane | 1.67 | — | 1.67 | 0.45 | 0.060 | 7.5 | 0.01 | 0.2 | 0.01 | 0.2 | particularly | none |
| ample | compound | resin | | | | | | | | | | | satisfactory | |
| 1-14 | B-2 | (material: | | | | | | | | | | | | |
| | | MR-7) | | | | | | | | | | | | |
| Ex- | specific | urethane | 1.67 | — | 1.67 | 0.43 | 0.065 | 6.62 | 0.01 | 0.2 | 0.02 | 0.2 | particularly | none |
| ample | compound | resin | | | | | | | | | | | satisfactory | |
| 1-15 | B-23 | (material: | | | | | | | | | | | | |
| | | MR-7) | | | | | | | | | | | | |
| Com- | comparative | urethane | 1.67 | — | 1.67 | 0 | 0 | 0 | 13 | 2.8 | 8 | 6 | poor | yes |
| parative | compound | resin | | | | | | | | | | | | |
| Ex- | H-1 | (material: | | | | | | | | | | | | |
| ample | | | | | | | | | | | | | | |
| 1-1 | | MR-7) | | | | | | | | | | | | |
| Com- | comparative | urethane | 1.67 | — | 1.67 | 0.047 | 0.002 | 23.5 | 4 | 2.8 | 8 | 6 | poor | yes |
| parative | compound | resin | | | | | | | | | | | | |
| Ex- | H-2 | (material: | | | | | | | | | | | | |
| ample | | | | | | | | | | | | | | |
| 1-2 | | MR-7) | | | | | | | | | | | | |
| Com- | comparative | urethane | 1.67 | — | 1.67 | 0.047 | 0.002 | 23.5 | 0.4 | 6 | 0.8 | 11.5 | poor | yes |
| parative | compound | resin | | | | | | | | | | | | |
| Ex- | H-2 (addition | (material: | | | | | | | | | | | | |
| ample | amount: | MR-7) | | | | | | | | | | | | |
| 1-3 | 10 times) | | | | | | | | | | | | | |
| Com- | comparative | urethane | 1.67 | — | 1.67 | 0.042 | 0.004 | 10.5 | 4 | 2.7 | 9 | 6.2 | poor | yes |
| parative | compound | resin | | | | | | | | | | | | |
| Ex- | H-3 | (material: | | | | | | | | | | | | |
| ample | | MR-7) | | | | | | | | | | | | |
| 1-4 | | | | | | | | | | | | | | |

As shown in Table 3 or 4, it was confirmed that, compared with the lenses for spectacles of Comparative Examples 1-1 to 1-4, the lenses for spectacles of Examples 1-1 to 1-15 had a low value of transmittance at the wavelength of 400 nm and had excellent blue light-blocking property.

Further, it was confirmed that, compared with the lenses for spectacles of Comparative Examples 1-1 to 1-4, the lenses for spectacles of Examples 1-1 to 1-15 had a low haze value and excellent transparency.

It was confirmed that the lenses for spectacles of Examples 1-1 to 1-15 maintained haze and transparency equivalent to those immediately after production even in the case of being aged under wet heat conditions, but the haze value increased and the transparency decreased in all of Comparative Examples 1-1 to 1-4.

Furthermore, it was also confirmed that, compared with the lenses for spectacles of Comparative Examples 1-1 to 1-4, the lenses for spectacles of Examples 1-1 to 1-15 had excellent light resistance and thus hardly had a yellowish tint.

Further, Examples 1-4, 1-12, and 1-13 are all examples in which the ultraviolet absorbing agent B (compound H-1, H-2, or H-3) was used in combination with the ultraviolet absorbing agent A, and it was confirmed that these examples also exhibited excellent effects in all evaluation items as compared with Comparative Examples in which a comparative compound corresponding to the ultraviolet absorbing agent B was used alone.

TABLE 5

| | | | | Ultra- | | | | | | | | | | |
|---|---|---|---|---|---|---|---|---|---|---|---|---|---|---|
| | Ultraviolet | | | violet | | | | | Evaluation | | | | | |
| | absorbing | Resin | | absorb- | Lens | Absorbance | | | Initial | | After wet | | | |
| | agent A or | | Re- | ing | re- | Ratio^{*1} | Ratio^{*2} | Ratio | performance | | heat aging | | | Yellow- |
| | Comparative | | flective | agent | flective | (400 | (410 | (Ratio^{*1}/ | Trans- | | Trans- | | Light | ish |
| | compound | Kind | index | B | index | nm) | nm) | Ratio^{*2}) | mittance | Haze | mittance | Haze | resistance | tint |
| Ex- | specific | urethane | 1.67 | — | 1.67 | 0.41 | 0.046 | 8.91 | 0.02 | 0.1 | 0.02 | 0.2 | satisfactory | none |
| ample | compound | resin | | | | | | | | | | | | |
| 2-1 | I-2 | (material: | | | | | | | | | | | | |
| | | MR-7) | | | | | | | | | | | | |
| Ex- | specific | urethane | 1.67 | — | 1.67 | 0.43 | 0.045 | 9.56 | 0.02 | 0.1 | 0.02 | 0.1 | satisfactory | none |
| ample | compound | resin | | | | | | | | | | | | |
| 2-2 | I-3 | (material: | | | | | | | | | | | | |
| | | MR-7) | | | | | | | | | | | | |
| Ex- | specific | urethane | 1.67 | — | 1.67 | 0.41 | 0.046 | 8.91 | 0.02 | 0.1 | 0.02 | 0.2 | satisfactory | none |
| ample | compound | resin | | | | | | | | | | | | |
| 2-3 | I-7 | (material: | | | | | | | | | | | | |
| | | MR-10) | | | | | | | | | | | | |
| Ex- | specific | urethane | 1.67 | H-3 | 1.67 | 0.41 | 0.046 | 8.91 | 0.01 | 0.3 | 0.01 | 0.4 | satisfactory | none |
| ample | compound | resin | | | | | | | | | | | | |
| 2-4 | I-2 | (material: | | | | | | | | | | | | |
| | | MR-174) | | | | | | | | | | | | |
| Ex- | specific | urethane | 1.67 | — | 1.67 | 0.43 | 0.032 | 13.43 | 0.02 | 0.2 | 0.02 | 0.3 | satisfactory | none |
| ample | compound | resin | | | | | | | | | | | | |
| 2-5 | I-23 | (material: | | | | | | | | | | | | |
| | | MR-7) | | | | | | | | | | | | |
| Ex- | specific | urethane | 1.67 | — | 1.67 | 0.164 | 0.012 | 13.67 | 0.01 | 0.2 | 0.01 | 0.4 | particularly | none |
| ample | compound | resin | | | | | | | | | | | satisfactory | |
| 2-6 | S-1 | (material: | | | | | | | | | | | | |
| | | MR-7) | | | | | | | | | | | | |
| Ex- | specific | urethane | 1.67 | — | 1.67 | 0.170 | 0.015 | 11.33 | 0.02 | 0.2 | 0.02 | 0.4 | particularly | none |
| ample | compound | resin | | | | | | | | | | | satisfactory | |
| 2-7 | S-18 | (material: | | | | | | | | | | | | |
| | | MR-7) | | | | | | | | | | | | |
| Ex- | specific | urethane | 1.67 | — | 1.67 | 0.182 | 0.020 | 9.1 | 0.02 | 0.3 | 0.02 | 0.5 | particularly | none |
| ample | compound | resin | | | | | | | | | | | satisfactory | |
| 2-8 | S-36 | (material: | | | | | | | | | | | | |
| | | MR-7) | | | | | | | | | | | | |
| Ex- | specific | episulfide | 1.70 | — | 1.70 | 0.182 | 0.020 | 9.1 | 0.01 | 0.2 | 0.01 | 0.3 | particularly | none |
| ample | compound | resin | | | | | | | | | | | satisfactory | |
| 2-9 | S-36 | | | | | | | | | | | | | |
| Ex- | specific | urethane | 1.67 | — | 1.67 | 0.103 | 0.011 | 9.36 | 0.01 | 0.1 | 0.01 | 0.2 | satisfactory | none |
| ample | compound | resin | | | | | | | | | | | | |
| 2-10 | T-29 | (material: | | | | | | | | | | | | |
| | | MR-7) | | | | | | | | | | | | |

TABLE 6

| | | | | Ultra- | | | | | | | | | | |
|---|---|---|---|---|---|---|---|---|---|---|---|---|---|---|
| | Ultraviolet | | | violet | | | | | Evaluation | | | | | |
| | absorbing | Resin | | absorb- | Lens | Absorbance | | | Initial | | After wet | | | |
| | agent A or | | Re- | ing | re- | Ratio^{*1} | Ratio^{*2} | Ratio | performance | | heat aging | | | Yellow- |
| | Comparative | | flective | agent | flective | (400 | (410 | (Ratio^{*1}/ | Trans- | | Trans- | | Light | ish |
| | compound | Kind | index | B | index | nm) | nm) | Ratio^{*2}) | mittance | Haze | mittance | Haze | resistance | tint |
| Ex- | specific | urethane | 1.67 | — | 1.67 | 0.49 | 0.074 | 6.62 | 0.03 | 0.2 | 0.03 | 0.3 | satisfactory | none |
| ample | compound | resin | | | | | | | | | | | | |
| 2-11 | U-17 | (material: | | | | | | | | | | | | |
| | | MR-7) | | | | | | | | | | | | |
| Ex- | specific | episulfide | 1.70 | — | 1.70 | 0.41 | 0.046 | 8.91 | 0.02 | 0.2 | 0.02 | 0.2 | particularly | none |
| ample | compound | resin | | | | | | | | | | | satisfactory | |
| 2-12 | I-2 | | | | | | | | | | | | | |
| Ex- | specific | urethane | 1.67 | H-1 | 1.67 | 0.41 | 0.046 | 8.91 | 0.02 | 0.2 | 0.02 | 0.3 | particularly | none |
| ample | compound | resin | | | | | | | | | | | satisfactory | |
| 2-13 | I-2 | (material: | | | | | | | | | | | | |
| | | MR-7) | | | | | | | | | | | | |
| Ex- | specific | urethane | 1.67 | H-2 | 1.67 | 0.41 | 0.046 | 8.91 | 0.02 | 0.3 | 0.02 | 0.3 | particularly | none |
| ample | compound | resin | | | | | | | | | | | satisfactory | |
| 2-14 | I-2 | (material: | | | | | | | | | | | | |
| | | MR-7) | | | | | | | | | | | | |
| Ex- | specific | urethane | 1.67 | — | 1.67 | 0.45 | 0.060 | 7.5 | 0.01 | 0.2 | 0.01 | 0.3 | particularly | none |
| ample | compound | resin | | | | | | | | | | | satisfactory | |
| 2-15 | B-2 | (material: | | | | | | | | | | | | |
| | | MR-7) | | | | | | | | | | | | |
| Ex- | specific | urethane | 1.67 | — | 1.67 | 0.43 | 0.065 | 6.62 | 0.01 | 0.2 | 0.01 | 0.2 | particularly | none |
| ample | compound | resin | | | | | | | | | | | satisfactory | |
| 2-16 | B-23 | (material: | | | | | | | | | | | | |
| | | MR-7) | | | | | | | | | | | | |
| Com- | comparative | urethane | 1.67 | — | 1.67 | 0 | 0 | 0 | 18 | 6.5 | 32 | 9.7 | poor | yes |
| parative | compound | resin | | | | | | | | | | | | |
| Ex- | H-1 | (material: | | | | | | | | | | | | |
| ample | | MR-7) | | | | | | | | | | | | |
| 2-1 | | | | | | | | | | | | | | |
| Com- | comparative | urethane | 1.67 | — | 1.67 | 0.047 | 0.002 | 23.5 | 11 | 8.2 | 24 | 12.4 | poor | yes |
| parative | compound | resin | | | | | | | | | | | | |
| Ex- | H-2 | (material: | | | | | | | | | | | | |
| ample | | MR-7) | | | | | | | | | | | | |
| 2-2 | | | | | | | | | | | | | | |
| Com- | comparative | urethane | 1.67 | — | 1.67 | 0.047 | 0.002 | 23.5 | 0.6 | 12 | 6.5 | 15 | poor | yes |
| parative | compound | resin | | | | | | | | | | | | |
| Ex- | H-2 (addition | (material: | | | | | | | | | | | | |
| ample | amount: | MR-7) | | | | | | | | | | | | |
| 2-3 | 10 times) | | | | | | | | | | | | | |
| Com- | comparative | urethane | 1.67 | — | 1.67 | 0.042 | 0.004 | 10.5 | 6 | 9.5 | 11 | 16 | poor | yes |
| parative | compound | resin | | | | | | | | | | | | |
| Ex- | H-3 | (material: | | | | | | | | | | | | |
| ample | | MR-7) | | | | | | | | | | | | |
| 2-4 | | | | | | | | | | | | | | |

As shown in Table 5 or 6, it was confirmed that, compared with the lenses for spectacles of Comparative Examples 2-1 to 2-4, the lenses for spectacles of Examples 2-1 to 2-16 had a low value of transmittance at the wavelength of 400 nm and had excellent blue light-blocking property.

Further, it was confirmed that, compared with the lenses for spectacles of Comparative Examples 2-1 to 2-4, the lenses for spectacles of Examples 2-1 to 2-16 had a low haze value and excellent transparency.

It was confirmed that the lenses for spectacles of Examples 2-1 to 2-16 maintained haze and transparency equivalent to those immediately after production even in the case of being aged under wet heat conditions, but the haze value increased and the transparency decreased in all of Comparative Examples 2-1 to 2-4.

Furthermore, it was also confirmed that, compared with the lenses for spectacles of Comparative Examples 2-1 to 2-4, the lenses for spectacles of Examples 2-1 to 2-16 had excellent light resistance and thus hardly had a yellowish tint.

Furthermore, the comparison between the lens for spectacles of Example 2-8 and the lens for spectacles of Example 2-9 confirmed that in a case where an episulfide resin is used, more excellent effects are obtained in both transmittance and haze.

Further, Examples 2-4, 2-13, and 2-14 are examples in which the ultraviolet absorbing agent B (compound H-1, H-2, or H-3) was used in combination with the ultraviolet absorbing agent A, and it was confirmed that these examples also exhibited excellent effects in all evaluation items as compared with Comparative Examples in which a comparative compound corresponding to the ultraviolet absorbing agent B was used alone.

In the lens for spectacles of Examples 2-1 to 2-16, the addition amount of the specific compound was set to twice the addition amount of the specific compound in each lens for spectacles of Examples 1-1 and the like and the thickness thereof was halved. From the results of Table 5 or 6, it can be seen that the lens for spectacles of the present disclosure exhibits the desired effect even in a case where the lens thickness thereof is reduced from 2 mm to 1 mm.

8. Confirmation of Thinning and Reduction in Weight of Spectacle Lens

In a case where a 65 mm diameter lens for spectacles having a lens power of −8 was produced using the composition prepared in Example 2, the edge thickness (lens edge thickness) was 8 mm.

On the other hand, in a case where a 65 mm diameter lens for spectacles having a lens power of −8 was produced using the composition prepared in Comparative Example 3, the edge thickness (lens edge thickness) was 9 mm.

From the above results, it was confirmed that the spectacle lenses of Examples have a smaller edge thickness (lens edge thickness), that is, the lenses have a lighter weight, in the case of the same lens power, as compared with the spectacle lenses of Comparative Examples.

The disclosure of JP2018-080033 filed on Apr. 18, 2018 is incorporated herein by reference in its entirety.

All documents, patent applications, and technical standards described in the present specification are incorporated herein by reference to the same extent as if each individual publication or patent application was specifically and individually indicated to be incorporated by reference.

What is claimed is:

1. A lens for spectacles comprising:
a resin having a refractive index of 1.65 or more; and
an ultraviolet absorbing agent A having, in a case where an absorbance at a maximum absorption wavelength is 1.0, an absorbance ratio at 410 nm of 0.10 or less and an absorbance ratio at 400 nm of 0.1 or more, where a proportion of the absorbance ratio at 400 nm to the absorbance ratio at 410 nm is 5.0 or more.

2. The lens for spectacles according to claim 1,
wherein the ultraviolet absorbing agent A is at least one selected from the group consisting of a benzoxazole compound, a benzoxazinone compound, and a benzodithiolane compound.

3. The lens for spectacles according to claim 1,
wherein the ultraviolet absorbing agent A is at least one selected from the group consisting of a compound represented by Formula (1), a compound represented by Formula (2), a compound represented by Formula (3), and a compound represented by Formula (4): 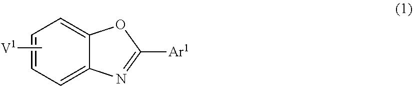
in Formula (1), V¹ represents a hydrogen atom or a monovalent substituent, and Ar¹ represents an aryl group or a heteroaryl group; 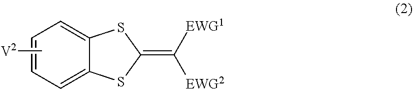
in Formula (2), EWG¹ and EWG² each independently represent a group having a Hammett substituent constant σp value of 0.2 or more, and V² represents a hydrogen atom or a monovalent substituent; 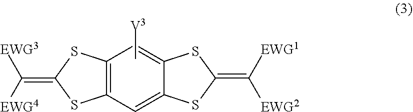
in Formula (3), EWG¹, EWG², EWG³, and EWG⁴ each independently represent a group having a Hammett substituent constant up value of 0.2 or more, and V³ represents a hydrogen atom or a monovalent substituent; and 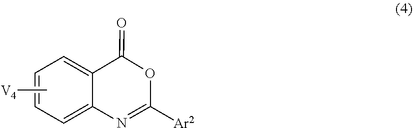
in Formula (4), V⁴ represents a hydrogen atom or a monovalent substituent, and Ar² represents an aryl group or a heteroaryl group.

4. The lens for spectacles according to claim 3,
wherein the ultraviolet absorbing agent A contains the compound represented by Formula (1), and
V¹ in Formula (1) contains an alkoxy group.

5. The lens for spectacles according to claim 3,
wherein the ultraviolet absorbing agent A contains the compound represented by Formula (1), and
Ar¹ in Formula (1) is a thiophene group.

6. The lens for spectacles according to claim 3,
wherein the ultraviolet absorbing agent A contains the compound represented by Formula (4), and
Ar² in Formula (4) is a thiophene group.

7. The lens for spectacles according to claim 3,
wherein the ultraviolet absorbing agent A contains the compound represented by Formula (2), and
in Formula (2), EWG¹ and EWG² each independently represent —COOR⁶, —SO₂R⁷, —CN, or —COR⁸, where R⁷ represents an aryl group, and R⁶ and R⁸ each independently represent an alkyl group.

8. The lens for spectacles according to claim 3,
wherein the ultraviolet absorbing agent A contains the compound represented by Formula (3), and
in Formula (3), EWG¹, EWG², EWG³, and EWG⁴ each independently represent —COOR⁶, —SO₂R⁷, —CN, or —COR⁸, where R⁷ represents an aryl group.

9. The lens for spectacles according to claim 1,
wherein the resin is an episulfide resin.

10. The lens for spectacles according to claim 1, which has a refractive index of 1.70 or more.

11. The lens for spectacles according to claim 1, further comprising an ultraviolet absorbing agent B different from the ultraviolet absorbing agent A,
wherein the ultraviolet absorbing agent B is at least one selected from a benzotriazole compound or a benzotriazine compound.

12. Spectacles comprising the lens for spectacles according to claim 1.
